(19) United States
(12) Patent Application Publication
(10) Pub. No.: US 2005/0049030 A1
(43) Pub. Date: Mar. 3, 2005

(54) Gaming machine with display device for variably displaying symbols thereon and capable of changing number or shapes of symbols under predetermined condition

(76) Inventor: Motoaki Tachikawa, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/892,103

(22) Filed: Jul. 16, 2004

(30) Foreign Application Priority Data
Jul. 18, 2003 (JP) JP2003-199206
Jul. 18, 2003 (JP) JP2003-199216

(51) Int. Cl. A63F 13/00

(52) U.S. Cl. 463/20

(57) ABSTRACT

The slot machine 1 is constructed so that when the game condition shifts to the free game (S5: YES), the use number of symbols which arc scrolled on each of the variable display portions 21 to 25 is made changeable according to the lottery result done at the start of the base game (s2) and the lottery of winning combination is conducted corresponding to the changed use number of symbols (S7). Further, the slot machine 1 is constructed so that when the game condition shifts to the free game (S5: YES), the enlargement multiple (shape) of symbols which are scrolled, stopped and displayed on each of the variable display portions 21 to 25 is made changeable according to the lottery result done at the start of the base game (s2) and the lottery of winning combination is conducted corresponding to the changed shape of symbols (S7).

### CROSS-REFERENCE TO THE RELATED APPLICATION (S)

This application is based upon and claims a priority from the prior Japanese Patent Application Nos. 2003-199206 and 2003-199216 both of which were filed on Jul. 18, 2003, the entire contents of which are incorporated herein by reference. This application is related to co-pending US Patent Application entitled to “GAMING MACHINE”, which is based upon and claims a priority from the prior Japanese Patent Application Nos. 2003-199996 filed on Jul. 22, 2003 and 2003-201071 filed on Jul., 24, 2003, and the inventor of which is Motoaki TACHIKAWA.

### BACKGROUND OF THE INVENTION

1. Field of the Invention

The present invention relates to a gaming machine which gives predetermined benefit to a player when symbols on a plurality of variable display portions stop along a pay line. In particular, the present invention relates to a gaming machine with a display device capable of changing a number or shape of symbols which are variably displayed on variable display portions of the display device.

2. Description of Related Art

Conventionally, in a slot machine, a plurality of reels on an outer periphery of each of which various symbols are formed, are rotatably supported, and medals and the like are paid out when the symbol on each reel is stopped and displayed along a pay line with a predetermined combination.

At this point of view, in slot machines popularized in foreign countries, after a SPIN button is pressed, a stop symbol for each reel is determined and the reels are rotated. And after a predetermined time is elapsed, each reel is automatically stopped with the determined stop symbol. Therefore, the player has no need to conduct game operation after pressing the SPIN button and can only expect that the combination of symbols automatically stopped becomes the predetermined combination. That is, games conducted in the conventional gaming machines are apt to become passive for the player.

Especially, in a case that game condition shifts to a free game in which a predetermined number (concerning with the game) of free spins (operations in which the reels are automatically started to rotate without newly inserting medals and the reels are stopped after a predetermined time is elapsed, thereafter medals are paid out according to the combination of stopped symbols) can be done, it concludes to be continued the state that the player cannot participate in the game (the player can only see the combination of stopped symbols) when the number of free spins becomes more and more. Thus, various devices are done in the conventional gaming machines to make the player have interest for games.

For example, in Japanese unexamined Publication No. 11-244453, it is disclosed a slot machine which is constructed so that after a game is started, not only combination lottery of symbol marks formed on each of three reels is conducted but also lottery of pay lines is done. In this slot machine, position and number of the pay lines becomes changeable against the combination of the symbol marks which are determined by the lottery and stopped and displayed. Thus, interest of the player for games can be continued till end of the game. And in the slot machine disclosed in the above reference, in a case that the number of the pay lines increases by the lottery, winning probability of the combination of symbol marks can be raised.

However, even in the slot machine disclosed in the above reference, there are many cases that the predetermined combination (winning combination) can be obtained if the last only one symbol is in good order in the combination, concerning with the symbols of the reels which are automatically stopped and displayed along the pay line. That is to say, there are still many cases which do not reach to the winning combination by a narrow margin.

And even in such cases, the player can only expect that the symbol combination automatically stopped becomes the predetermined combination. At this point, such games are clearly passive games.

### SUMMARY OF THE INVENTION

The present invention has been done to accomplish the above problems and has an object to provide a gaming machine in which it can be realized a state that a specific symbol combination can be easily won by changing a use number of symbols variably displayed on variable display portions used in a game when a specific condition is realized.

Further, the present invention has another object to provide a gaming machine in which it can be realized a state that a specific symbol combination can be easily won by changing shapes of symbols variably displayed on variable display portions used in a game when a specific condition is realized.

That is to say, according to one aspect of the present invention, it is provided a gaming machine having a display device with a plurality of variable display portions on each of which symbols are variably displayed, a payout being given when the symbols variably displayed on each variable display portion are stopped along a pay line with a predetermined winning combination, the gaming machine comprising:

a variable display controller for controlling variable display of the symbols conducted on each of the variable display portions;

a symbol number controller for controlling a use number of the symbols variably displayed on each of the variable display portions, when a specific condition is realized; and

a winning combination lottery device for conducting a lottery of the winning combination corresponding to the symbol number controlled by the symbol number controller.

In the gaming machine constructed according to the above, when the specific condition is realized, the number of the symbols variably displayed on each of the variable display portions is determined by the symbol number controller and the lottery of the winning combination is conducted according to the number of the symbols determined by the symbol number controller. Therefore, the number of the symbols which are variably displayed on each of the variable display portions utilized in the game can be changed. Thereby, since the lottery of the winning combination is conducted according to the changed number of the symbols, various winning combinations can be easily won. As a result, it can be given to the player expectation that the specific winning combination can be easily won and interest for games can be highly maintained.

Further, according to another Aspect of the present invention, it is provided a gaming machine having a display device with a plurality of variable display portions on each of which symbols are variably displayed, a payout being given when the symbols variably displayed on each variable display portion are stopped along a pay line with a predetermined winning combination, the gaming machine comprising:

a variable display controller for controlling variable display of the symbols conducted on each of the variable display portions;

a symbol shape controller for controlling shapes of the symbols variably displayed on each of the variable display portions, when a specific condition is realized; and

a winning combination lottery device for conducting a lottery of the winning combination corresponding to the symbol shape controlled by the symbol shape controller.

In the gaming machine constructed according to the above, when the specific condition is realized, the shapes of the symbols variably displayed on each of the variable display portions arc determined by the symbol shape controller and the lottery of the winning combination is conducted according to the shapes determined by the symbol shape controller. Therefore, the shapes of the symbols which are variably displayed on each of the variable display portions utilized in the game can be changed. Thereby, since the lottery of the winning combination is conducted according to the changed shapes of the symbols, various winning combinations can be easily won. As a result, it can be given to the player expectation that the specific winning combination can be easily won and interest for games can be highly maintained.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view of the slot machine,

FIG. 2 is an exploded perspective view of a lower liquid crystal display,

FIG. 3 is an explanatory view schematically showing symbol rows which are variably displayed on variable display portions in a base game,

FIG. 4 is a block diagram schematically showing a control system of the slot machine,

FIG. 5 is a block diagram schematically showing a liquid crystal circuit of the lower liquid crystal display device,

FIG. 6 is an explanatory view showing a winning combination lottery table utilized in the base game,

FIG. 7 is an explanatory view of a lottery table utilized in a free game,

FIG. 8 is an explanatory view showing a winning combination lottery table utilized in a first free game,

FIG. 9 is an explanatory view showing a winning combination lottery table utilized in a second free game,

FIG. 10 is a flowchart of a main process program,

FIG. 11 is an explanatory view showing an example of symbols which are stopped and displayed on the variable display portions in the first free game,

FIG. 12 is an explanatory view showing symbol rows which are variably displayed on the variable display portions in the first free game,

FIG. 13 is an explanatory view showing an example of symbols which are stopped and displayed on the variable display portions in the first free game,

FIG. 14 is an explanatory view showing symbol rows which are stopped and displayed on the variable display portions in the second free game,

FIG. 15 is an explanatory view showing a case that the pay lines increase,

FIG. 16 is an explanatory view showing the pay line,

FIG. 17 is an explanatory view showing an example of the symbols which are stopped and displayed on the variable display portions in the first free game,

FIG. 18 is an explanatory view showing an example of the symbols which are displayed on the variable display portions, the symbols being utilized in the second free game,

FIG. 19 is an explanatory view showing a case that the pay lines increase,

FIG. 20 is an explanatory view showing the pay line,

FIG. 21 is an explanatory view showing the symbol rows which are variably displayed on the variable display portions in the first free game,

FIG. 22 is an explanatory view showing the symbol rows which are variably displayed on the variable display portions in the second free game,

FIG. 23 is an explanatory view showing a lottery table to determine the symbol every display portion, the symbol being stopped and displayed on the pay line, and

FIG. 24 is an explanatory view showing a lottery table to determine the symbol every display portion, the symbol being stopped and displayed on the pay line.

### DETAILED DESCRIPTION OF THE PREFERRED EMBODIMENTS

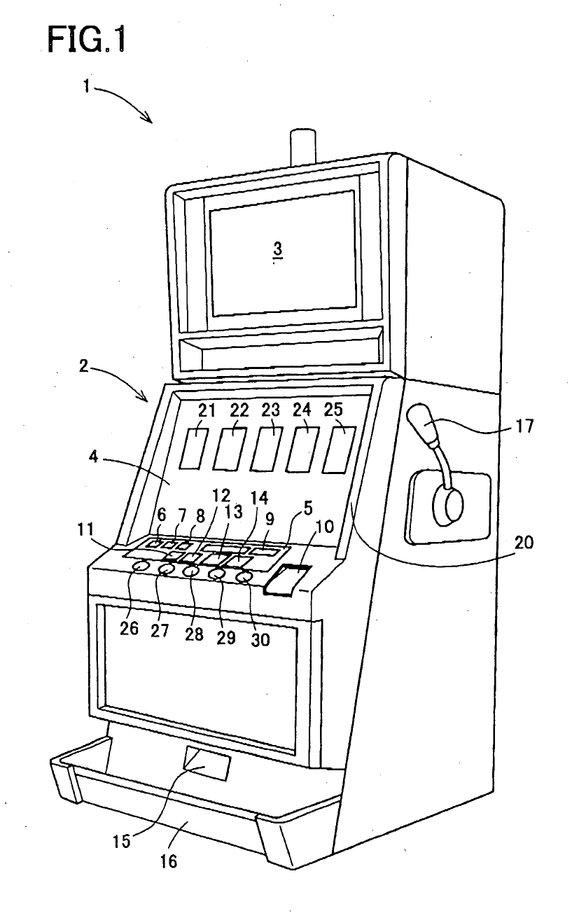

Hereinafter, as the gaming machine according to the present invention, the first embodiment embodying the present invention in the slot machine will be described with reference to the drawings. First, an outline construction of the slot machine according to the first embodiment will described with reference to FIG. 1. FIG. 1 is a perspective view of the slot machine.

In FIG. 1, the slot machine 1 has a cabinet 2 constructing a whole of the slot machine 1. At a front upper part of the cabinet 2 an upper liquid crystal display 3 is arranged, and at a front central part of the cabinet 2 a lower liquid crystal display 4 is arranged. Here, the upper liquid crystal display 3 is constructed from a liquid crystal display device which is generally used, and the lower liquid crystal display 4 is constructed from, so called, a transparent liquid crystal display device. On the upper liquid crystal display 3, game operation method, kinds of winning combinations and payout therefor and information concerning with the game such as various effects thereof are displayed. And on the lower liquid crystal display 4, as shown in FIG. 1, five variable display portions 21, 22, 23, 24, and 25 are basically displayed and various symbols (mentioned later) are scrolled to the downward direction from the upward direction while being variably displayed on each of the variable display portions 21 to 25. Here, the detailed construction of the lower liquid crystal display 4 will be described hereinafter.

A control panel 5, which is projected frontward, is formed below the lower liquid crystal display 4, and from the most left side on the control panel 5, a change button 6, a payout (cashout) button 7, a help button 8 are arranged. And a coin insertion slot 9 and a bill insertion portion 10 are arranged at the right side of help button 8. Further, from the left side, a 1-BET button 11, a SPIN/REPEAT BET button 12, a 3-BET button 13 and a 5-BET button 14 are positioned at the front side on the control panel 5.

Here, the change button 6 is pressed when exchanging the bill inserted in the bill insertion portion 10, and the exchanged coins are paid out through a coin payout chute 15 to a coin tray 16 which is formed at the lower part of the cabinet 2. To the change button 6, a change switch 62 (explained hereinafter) is attached, and a switch signal is output to a CPU 50 from the change switch 62 based on press of the change button 6.

The payout button 7 is usually pressed when games are terminated, and when the payout button 7 is pressed coins got in games are paid out through the coin payout chute 15 to the coin tray 16. Here, to the payout button 7, a payout (cashout) switch 63 (mentioned hereinafter) is attached and a switch signal is output to the CPU 50 from the payout switch 63 based on press of the payout button 7.

The help button 8 is pressed when the player cannot understand game operation method, and when the help button 8 is pressed, various help information is displayed on the upper liquid crystal display 3 or the lower liquid crystal display 4. To this help button 8, a help switch 64 (mentioned hereinafter) is attached and a switch signal is output to the CPU 50 from the help switch 64 based on press of the help button 8.

To the coin insertion slot 9, a coin sensor 65 (mentioned hereinafter) is positioned, and when the coin is inserted in the coin insertion slot 9 a coin detection signal is output to the CPU 50 through the coin sensor 65. And to the bill insertion portion 10 a bill sensor 66 (mentioned hereinafter) is positioned, and when the bill is inserted in the bill insertion portion 10 a bill detection signal is output to the CPU 60 through the bill sensor 66.

As for the 1-BET button 11, every the 1-BET button is pressed one credit is betted, and to the 1-BET button 11, a 1-BET switch 59 is attached and when the 1-BET button 11 is pressed a switch signal is output to the CPU 50 from the 1-BET switch 59 based on press of the 1-BET button 11.

The SPIN/REPEAT BET button 12 is the button to start games from the present bet number or the previous bet number by press thereof, thereby variable display of the symbols is started on the variable display portions 21 to 25 of the lower liquid crystal display 4. To the SPIN/REPEAT BET button 12, a spin switch 58 (mentioned later) is attached, and when the SPIN/REPEAT BET button 12 is pressed a switch signal is output to the CPU 50 from the spin switch 58 based on press of the SPIN/REPEAT BET button 12. Here, as the bet number which can be betted by press of the SPIN/REPEAT BET button 12, there may exist 1, 2, 3 and 5 bets.

The 3-BET button 13 is the button to start games from 3 bets on the basis of press thereof. To this 3-BET button 13, a 3-BET switch 60 (mentioned hereinafter) is attached and when the 3-BET button 13 is pressed a switch signal is output to the CPU 60 from the 3-BET switch 60. And the 5-BET button 14 is the button to start games from 5 bets on the basis of press thereof. To the 5-BET button 12, a 5-BET switch 61 is attached and when the 5-BET button is pressed a switch signal is output to the CPU 50 from the 5-BET switch 61 on the basis of press thereof.

Further, at the lower part of the cabinet 2, the coin payout chute 15 is formed and the coin tray 16 to receive coins paid out from the coin payout chute 15 is provided. In the coin payout chute 15, a coin detection part 73 constructed from a sensor and the like is positioned and the coin detection part 73 detects the number of coins paid out from the coin payout chute 15.

At the most front side of the control panel 5, stop buttons 26 to 30 are provided corresponding to each of the variable display portions 21 to 25, respectively. Here, as mentioned hereinafter, although these stop buttons are pressed when the symbols, which are scrolled on the variable display portions, are stopped and displayed thereon, the symbols cannot be stopped at timing of the press operation of the stop buttons 26 to 30. The switch signal output from the stop button switch 67 based on press of each of the stop buttons 26 to 30 is utilized to the end only as a trigger when the symbols scrolled on the variable display portions are stopped and displayed.

Further, at the side plane (the right side plane in FIG. 1) of the cabinet 2, a start lever 17 is arranged rotatably within a predetermined angle range. To the start lever 17. a start switch 57 (mentioned hereinafter) is attached and when the start lever 17 is rotated a switch signal occurring from the start switch 57 is output to the CPU 50.

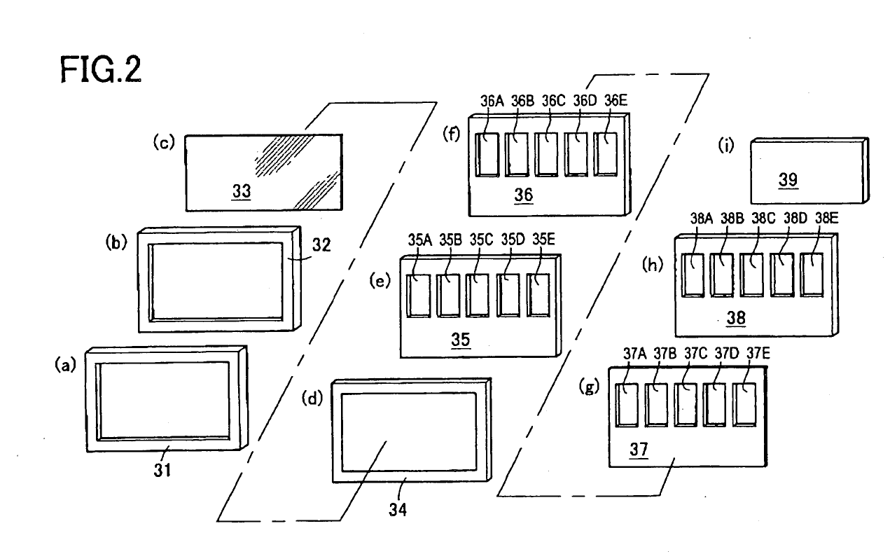

Next, it will be described a detailed construction of the lower liquid crystal display 4 with reference to FIG. 2. FIG. 2 is an exploded perspective view of the lower liquid crystal display 4.

In FIG. 2, the lower liquid crystal display 4 is construed by arranging from the front side of the slot machine 1; the reel glass base 31, the bezel metal frame 32, the transparent liquid crystal panel 33, the liquid crystal holder 34, the diffusion sheet 35, the light guiding plate 36, the white reflector 37, the rear holder 38 and the antistatic sheet 39. In the diffusion sheet 35, three openings 35A, 35B, 35C, 35D, 35E are formed. Similarly, in the light guiding plate 36, the reflector 37 and the rear holder 38, three openings 36A, 36B, 36C, 36D, 36E, 37A, 37B, 37C, 37D, 37E, 38A, 38B, 38C, 38D, 38E are formed respectively, so as to coincide with the openings 35A, 35B, 35C, 35D, 35E. Here, the openings 35A˜38A construct the variable display portion 21 (see FIG. 1) by superimposing so as to coincide with each other. Similarly, the openings 35B˜38B construct the variable display portion 22 (see FIG. 1) by superimposing so as to coincide with each other and the openings 35C˜38C construct the variable display portion 23 (see FIG. 1) by superimposing so as to coincide with each other. And similarly, the openings 35D˜38D construct the variable display portion 24 (see FIG. 1) by superimposing so as to coincide with each other and the openings 35E˜38E construct the variable display portion 25 (see FIG. 1) by superimposing so as to coincide with each other.

Here, the openings 35A˜35E of the diffusion sheet 35 and the openings 36A˜36E of the light guiding plate 36 construct the light transmitting areas to retain visibility of the variable display portions 21 to 25.

And at an upper and lower ends of the light guiding plate 36, a pair of cathode ray tubes (not shown) are arranged as light source of the liquid crystal panel 33. And at an upper and lower positions in the rear side of each of openings 38A˜38D in the holder 38, a pair of cold cathode ray tubes (not shown) may be arranged.

The liquid crystal panel 33 is a transparent electric display panel on which transparent electrodes such as Ito are formed, and the circumference in rear side of the display portion of the liquid crystal panel 33 is hold by the liquid crystal holder 34. The light guiding plate 36 is made of the light transmitting resin panel, and in the light guiding plate 36 lens cut portions are formed, the lens cut portions guiding light emitted from the cold cathode ray tubes (not shown) positioned at side positions to the rear side of the liquid crystal panel 33. The light diffusion sheet 35 is made from a light transmitting resin sheet and diffuses light led thereto by the light guiding plate 36 and levels light irradiated to the liquid crystal panel 33. The liquid crystal holder 34 for holding the liquid crystal panel 33, the diffusion sheet 35 and the light guiding plate 36 are assembled into one-piece construction and circumference thereof is inserted in the bezel metal frame 32. Thereby, the front side of the display portion in the liquid crystal panel 33 is retained by the bezel metal frame 32.

Circumferences of the liquid crystal holder 34, the light diffusion sheet 35 and the light guiding plate 36, which are inserted in the bezel metal frame 32 and assembled into one-piece construction, is further inserted in the reel glass base 31 and retained by the reel glass base 31 in a state that the front display plane of the liquid crystal panel 33 is opened.

The rear holder 38 is made from a white resin plate and retains to the reel glass base 31 the bezel metal frame 32 supported to the reel glass base 31, the liquid crystal holder 34 holding the liquid crystal panel 33, the light diffusion sheet 35 and the light guiding plate 36 from the rear sides thereof. The rear holder 38 also functions as a reflecting plate for reflecting light emitted from the cold cathode ray tubes to the light guiding plate 36 toward the liquid crystal panel 33. The antistatic sheet 39 is made transparent and adhered to the rear plane of the rear holder 38 by double-sided adhesive tape, thereby the antistatic sheet 39 covers the rear plane of each of the openings 38A˜38E formed in the rear holder 38.

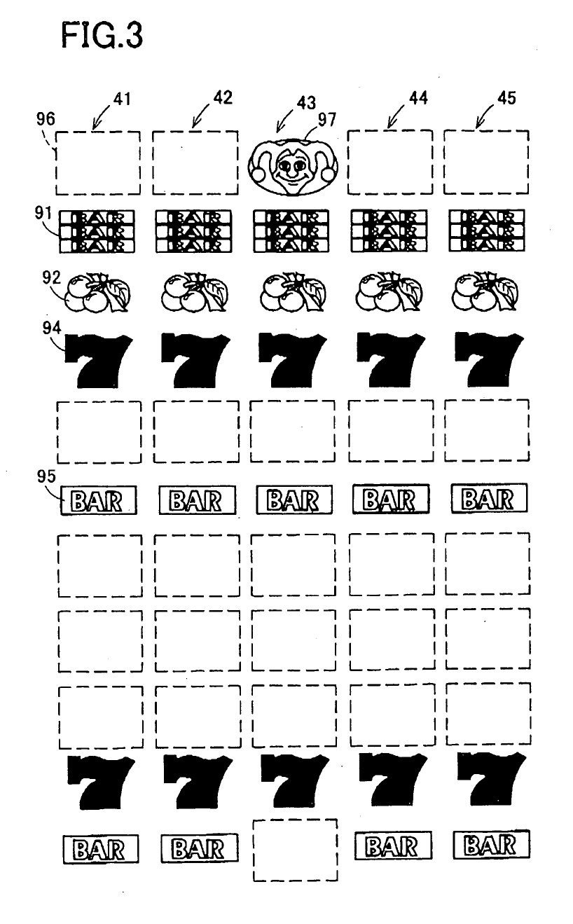

Next, according to FIG. 3, it will be described symbol rows which are variably displayed on the variable display portions 21 to 25 while scrolling thereon. FIG. 3 is an explanatory view showing symbol rows utilized in the base game, and the symbol row 41 is the symbol row which is variably displayed on the variable display portion 21, the symbol row 42 is the symbol row which is variably displayed on the variable display portion 22, the symbol row 43 is the symbol row which is variably displayed on the variable display portion 23, the symbol row 44 is the symbol row which is variably displayed on the variable display portion 24 and the symbol row 45 is the symbol row which is variably displayed on the variable display portion 25.

Here, the symbol rows 41, 42, 44 and 45 commonly have the same arrangement of the symbols and such arrangement of the symbols is constructed from eleven symbols in which the triple BAR 91, the cherry 92, the symbol seven 94, the single BAR 95 and the blank (no symbol exists) 96 are voluntarily combined.

And although the symbol row 43 is as same as the symbol row 41, 42, 44, 45 at the point that the triple BAR 91, the cherry 92, the symbol seven 94 the single Bar 95 and the blank 96 are combined, one joker 97 is further arranged in the symbol row 43. This joker 97, as mentioned hereinafter, functions as a symbol to shift to the free game in the base game, and when the joker 97 is stopped and displayed on the pay line (mentioned later) in the variable display portion 23, the game condition shifts to the free game from the base game. And in the free game, the joker 97 functions as a symbol according to which the payout becomes twice.

Here, when the symbol rows 41 to 45, which are scrolled on the variable display portions 21 to 25 respectively, are stopped and displayed thereon, three symbols are stopped and displayed on each variable display portion.

And various winning combinations are set beforehand based on a plurality of symbol combinations and when the symbol combination corresponding to the winning combination is stopped on the pay line, coins are paid out from the coin payout chute 15 according to the winning combination. The above mentioned points are as same as those in the conventional slot machine, therefore detailed description thereof will be omitted.

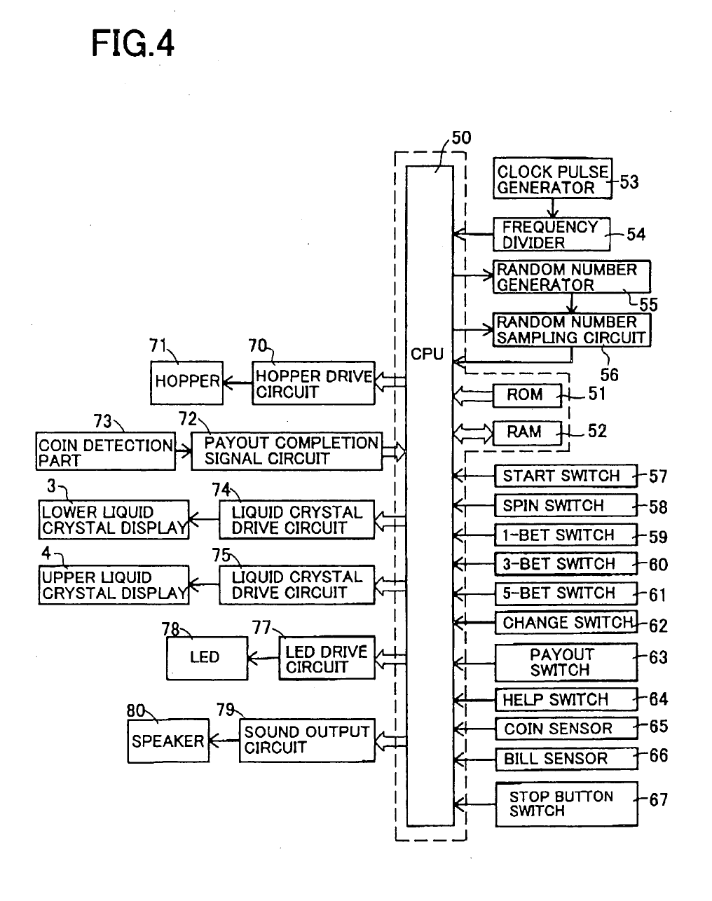

Next, it will be described a construction of the control system in the slot machine 1 with reference to FIG. 4. FIG. 4 is a block diagram schematically showing the control system in the slot machine 1.

In FIG. 4, the control system of the slot machine 1 is basically constructed from the CPU 50, and a ROM 51 and a RAM 52 are connected to the CPU 50. The ROM 51 stores main process program mentioned later, various effect programs for executing various effects on the upper liquid crystal display 3 and the lower liquid crystal display 4 according to progress in games, a lottery table utilized in lottery of the winning combination in the base game, a lottery table utilized in lottery of contents of free games, a lottery table utilized in lottery of the winning combination corresponding Lo free games, various programs necessary for controlling the slot machine 1 and various data tables and the like. And the RAM 62 is a memory for temporarily storing various data calculated by the CPU 50.

And to the CPU 50, a clock pulse generator 53 for generating standard clock pulses and a frequency divider 54 are connected, and a random number generator 55 and a sampling circuit 56 are also connected. Random number sampled by the random number generator 56 is utilized in various lotteries of the winning combinations, the effects and the like. Further, to the CPU 50, the start switch 57 attached to the start lever 17, the spin switch 58 attached to the SPIN/REPEAT BET button 12, the 1-BET switch 59 attached to the 1-BET button 11, the 3-BET switch 60 attached to the 3-BET button 13, the 5-BET switch 61 attached to the 5-BET button 14, the change switch 62 attached to the change button 6, the payout switch 63 attached to the payout button 7 and the help switch 64 attached to the help button 8 are connected respectively. The CPU 50 controls the slot machine 1 to execute various operations corresponding to each button, based on the switch signal output from each switch when such buttons are pressed.

Further, to the CPU 60, the coin sensor 65 positioned in the coin insertion slot 9 and the bill sensor 66 positioned in the bill insertion portion 10 are connected respectively. The coin sensor 65 detects coins inserted from the coin insertion slot 9 and the CPU 50 calculates the number of inserted coins based on the coin detection signal output from the coin sensor 65. The bill sensor 66 detects the kind and sum of bill and the CPU 50 calculates the number of coins equivalent to sum of bill, based on the bill detection signal output from the bill sensor 66. And to the CPU 50, the stop button switches 67 attached to the stop buttons 26 to 30 are connected. When press operation of the stop buttons 26 to 30 is conducted, switch signals are output from the stop button switches 67 and the CPU 50 stops and displays the symbols which are scrolled on the variable display portions 21 to 25, based on switch signals.

To the CPU 50, a hopper 71 is connected through a hopper drive circuit 70. When a drive signal is output to the hopper circuit 70 from the CPU 50, the hopper 71 pays out predetermined number of coins from the coin payout chute 15

And to the CPU 50, a coin detection part 73 is connected through a payout completion signal circuit 72. The coin detection part 73 is arranged in the coin payout chute 15 and when the coin detection part 73 detects that a predetermined number of coins are paid out from the coin payout chute 15, the payout completion signal is output to the payout completion signal circuit 72 from the coin detection part 73. Based on this, the payout completion signal circuit 72 outputs the payout completion signal to the CPU 50. Further, to the CPU 50, the upper liquid crystal display 3 is connected through a liquid crystal drive circuit 74 and the lower liquid crystal display 4 is connected through a liquid crystal drive circuit 75.

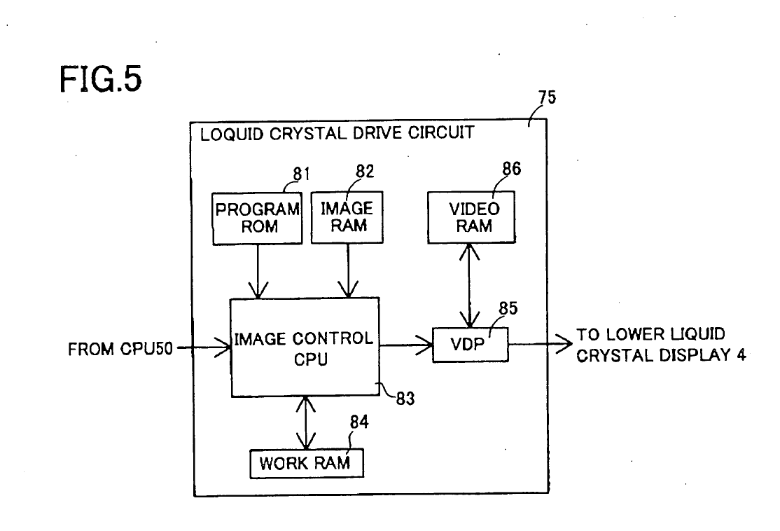

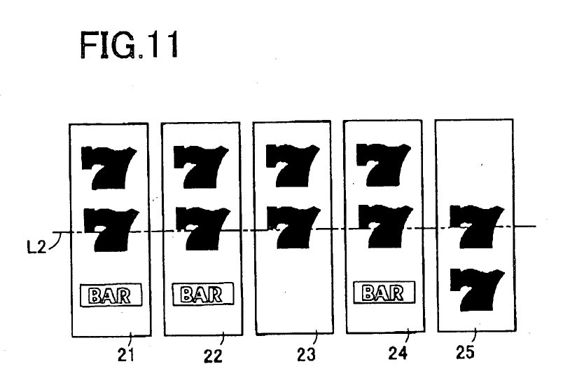

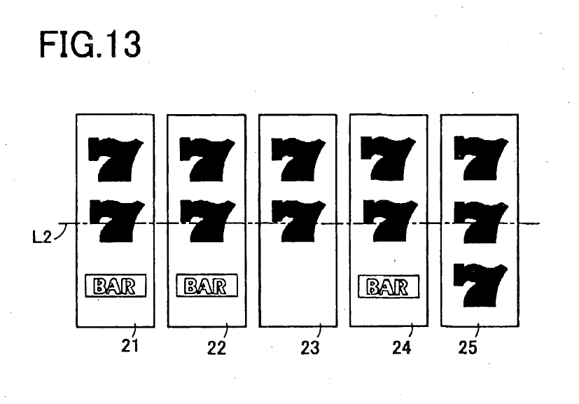

At this point of view, as shown in FIG. 5, the liquid crystal drive circuit 74 is constructed from a program ROM 81, an image ROM 82, an image control CPU 83, a work RA M 84, a VDP (Video Display Processor) 85 and a video RAM 86. And in the program ROM 81, an image control program concerning with display on the lower liquid crystal display 4 and various selection tables are stored. Further, in the image ROM 82, for example, it is stored dot data for forming images such as the symbol rows 41˜45 in FIG. 3 displayed on the lower liquid crystal display 4 (or variable display portions 21 to 25) and the symbol rows 41˜45 shown in FIGS. 11 and 13. And the image control CPU 83 determines images displayed on the lower liquid crystal display 4 among the dot data stored in the image ROM 82 beforehand, according to the image control program stored in the program ROM 81 based on parameters set by the CPU 50. And the work RAM 84 functions as the temporary memory when the above image control program is executed by the image control CPU 83. Further, the VDP 85 forms images corresponding to display contents determined by the image control CPU 83 and outputs the images to the lower liquid crystal display 4. Thereby, for example, the symbol rows 41˜45 of FIG. 3 and the symbol rows 41˜45 of FIGS. 11 and 13 are scrolled and displayed on the lower liquid crystal display 4 (or variable display portions 21 to 25). Here, the video RAM 86 functions as the temporary memory when images are formed by the VDP 85.

And to the CPU 50, LEDs 78 are connected through a LED drive circuit 77. A plurality of LEDs 78 are arranged on the front plane of the slot machine 1 and the LEDs 78 are controlled so as to turn on based on the drive signals from the CPU 50. Further, a speaker 80 and a sound output circuit 79 are connected to the CPU 50 and the speaker 80 produces various effective sounds when various effects are conducted based on the output signal from the sound output circuit 79.

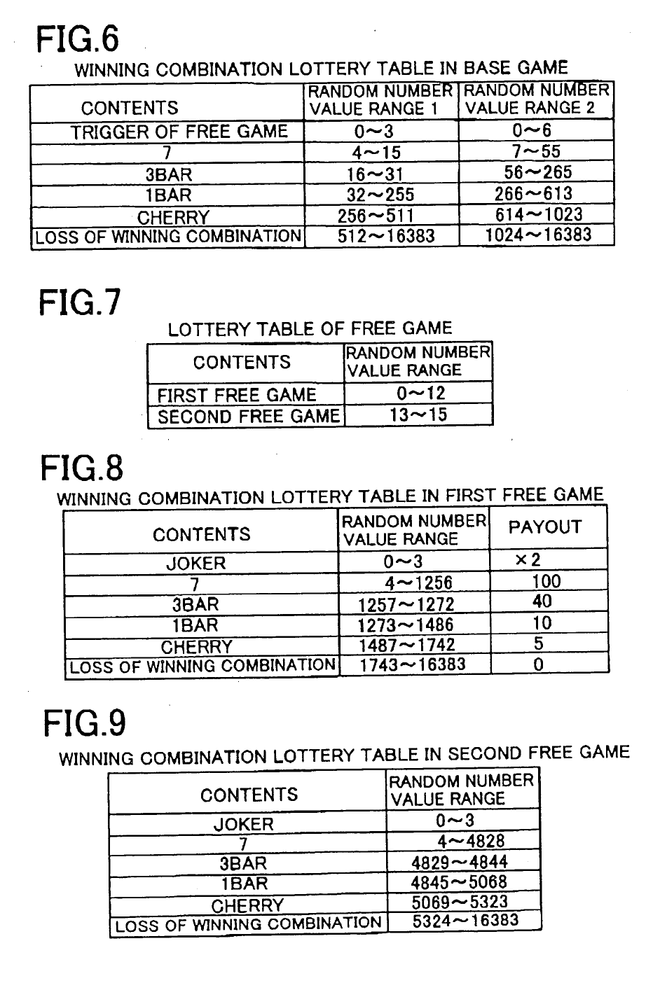

Here, in a case that the base games are conducted in the slot machine 1, the lottery table utilized when the lottery of the winning combination is done will be described with reference to FIG. 6. FIG. 6 is an explanatory view showing the lottery table of the winning combination utilized in the base games.

In FIG. 6, a range of random number values utilized in the lottery table of the winning combination lie within 0˜16383. Here, a range 1 of random number values will be explained. That is to say, in a case that the random number value sampled by the random number sampling circuit 56 lies in a range of 0˜3, the free game is triggered. In this case, the joker 97 is stopped and displayed on the pay line in the variable display portion 23 and the game condition can be shifted to the free game. Here, the free game is a game conducted after the base game is done and is generally beneficial for the player in many cases. For example, when the game condition shifts to the free game, games are continuously done during 10 games, 20 games or 30 games, corresponding rank of the free game. At that time, in the free game, winning probability for winning various winning combinations is generally set high, therefore the player can get a lot of coins in many cases.

Here, two kinds of free games such as the first free game and the second free game are set beforehand.

And in a case that the random number value sampled by the random number sampling circuit 56 lies in a range of 4˜15, the winning combination of the seven (7) is won. In this case, the symbol seven 94 is stopped and displayed on the pay line in each of the variable display portions 21 to 25. Similarly, if the random number value sampled lies in a range of 16˜31, the winning combination of the triple BAR is won. In this case, the triple BAR 91 is stopped and displayed on the pay line in each of the variable display portions 21 to 25. And similarly, if the random number value sampled lies in a range of 32˜255, the winning combination of the single BAR is won. In this case, the single BAR 95 is stopped and displayed on the pay line in each of the variable display portions 21 to 25. And if the random number value sampled lies in a range of 256˜511, the winning combination of the cherry is won. In this case, the cherry 92 is stopped and displayed on the play line in each of the variable display portions 21 to 25.

Here, in a case that the random number value lies in a range of 512˜16383, it leads to loss of winning combination (any winning combination cannot be won). In this case, symbol combination other than the winning combination is stopped and displayed on the pay line in each of variable display portions 21 to 25.

Further, a range 2 of random number values will be explained. That is to say, in a case that the random number value sampled by the random number sampling circuit 56 lies in a range of 0˜6, the free game is triggered. In this case, the joker 97 is stopped and displayed on the pay line in the variable display portion 23 and the game condition can be shifted to the free game.

And in a case that the random number value sampled by the random number sampling circuit 56 lies in a range of 7˜55, the winning combination of the seven (7) is won. In this case, the symbol seven 94 is stopped and displayed on the pay line in each of the variable display portions 21 to 25. Similarly, if the random number value sampled lies in a range of 56˜265, the winning combination of the triple BAR is won. In this case, the triple BAR 91 is stopped and displayed on the pay line in each of the variable display portions 21 to 25. And similarly, if the random number value sampled lies in a range of 266˜613, the winning combination of the single BAR is won. In this case, the single BAR 95 is stopped and displayed on the pay line in each of the variable display portions 21 to 25. And if the random number value sampled lies in a range of 614˜1023, the winning combination of the cherry is won. In this case, the cherry 92 is stopped and displayed on the play line in each of the variable display portions 21 to 25.

Here, in a case that the random number value lies in a range of 1024˜16383, it leads to loss of winning combination (no winning combination can be won). In this case, symbol combination other than the winning combination is stopped and displayed on the pay line in each of variable display portions 21 to 25. Comparing the range 1 with the range 2, the range that loss of winning combination occurs is wider in the range 1 than in the range 2.

Next, patterns of the pay line will be described with reference to FIG. 16. FIG. 16 is an explanatory view showing the pay line. Here, only the center pay line L2 is made active.

In the example shown in FIG. 16, it is shown a case that the symbol seven 94 is stopped and displayed along the center pay line L2.

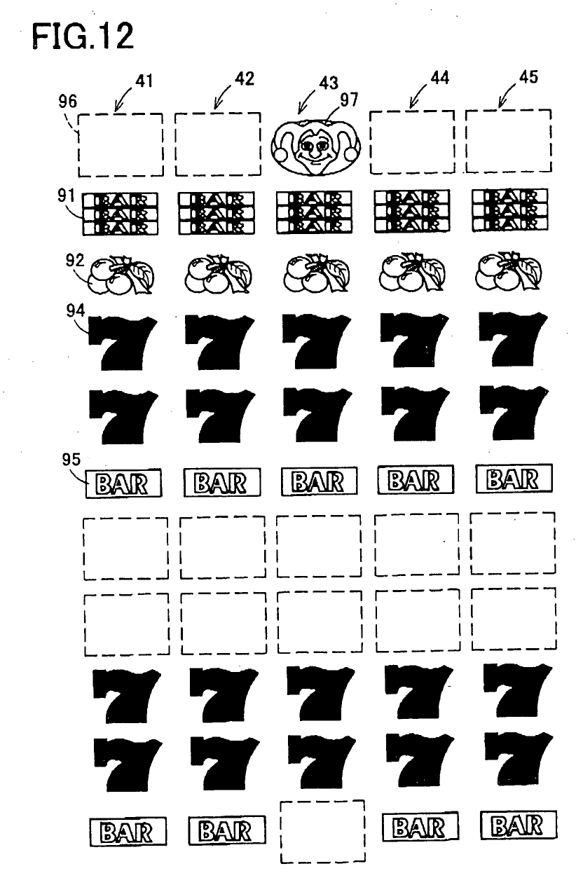

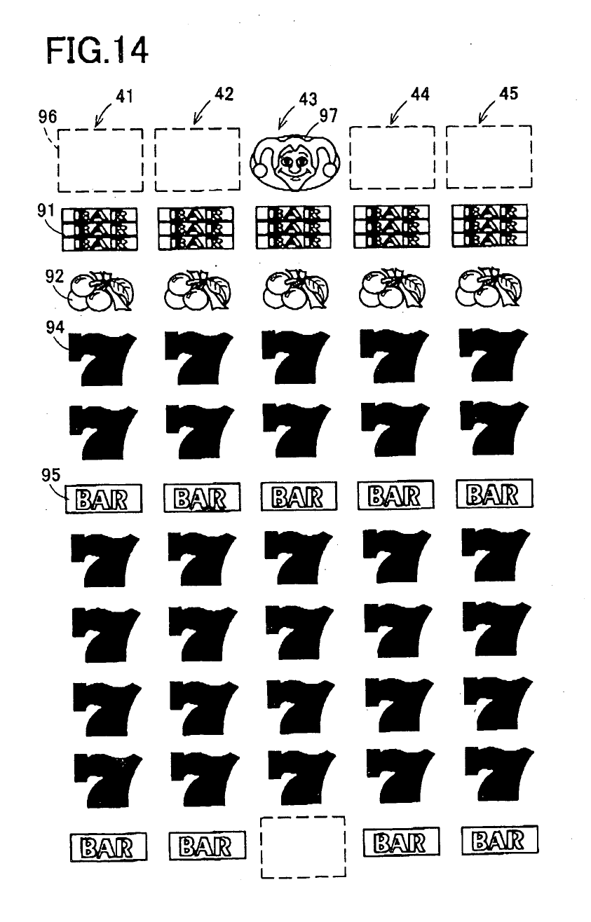

Next, it will be explained with reference to FIGS. 7, 12 and 14 the lottery table utilized when the lottery of free game is done and symbol rows which are used in the free game and displayed on each of the variable display portions 21 to 25. FIG. 7 is an explanatory view showing the lottery table of the free game. FIG. 12 is an explanatory view showing the symbol rows which are utilized in the first free game and displayed on each of the variable display portions 21 to 25. FIG. 14 is an explanatory view showing the symbol rows which are utilized in the second free game and displayed on each of variable display portions 21 to 25.

Here, as mentioned above, if the joker 97 is stopped and displayed on the pay line in the variable display portion 23, the game condition can be shifted to the free game after the base game is finished. As the free game, the first game and the second free game are provided beforehand.

As shown in FIG. 7, the random number values utilized in the lottery table of the free game lie within 0˜15. And in a case that the random number value sampled by the random number sampling circuit 56 lies in a range of 0˜12, the game condition is shifted to the first free game after the base game is finished. Further, when the first free game is conducted, the symbol rows 41, 42, 43, 44 and 45 shown in FIG. 12 are utilized. Here, comparing the symbol rows in the first free game with the symbol rows in the base game shown in FIG. 3, two blanks (area that no symbol exists) 96 are changed to the symbol sevens 94 respectively in the symbol rows 41, 42, 43, 44 and 45 in FIG. 12, as a result, two symbol sevens 94 are increased.

And if the random number value lies in a range of 13˜15, the game condition is shifted to the second free game after the base game is finished. Further, when the second free game is conducted, the symbol rows 41, 42, 43, 44 and 45 shown in FIG. 14 are utilized. Here, comparing the symbol rows in the second free game with the symbol rows in the base game shown in FIG. 3, four blanks (area that no symbol exists) 96 are changed to the symbol sevens 94 respectively in the symbol rows 41, 42, 43, 14 and 45 in FIG. 14, as a result, four symbol sevens 94 are increased.

Next, in a case that the first free game is conducted in the slot machine 1, the lottery table utilized when the lottery of the winning combination is conducted will be described with reference to FIG. 8. FIG. 8 is an explanatory view showing the lottery table of the winning combination utilized when the first free game is done.

In FIG. 8, a range of random number values utilized in the lottery table of the winning combination lie within 0˜16383. In a case that the random number value sampled by the random number sampling circuit 56 lies in a range of 0˜3, the joker is won. In this case, the joker 97 is stopped and displayed on the pay line in the variable display portion 23 and the payout becomes twice.

And in a case that the random number value sampled by the random number sampling circuit 56 lies in a range of 4˜1256, the winning combination of the seven (7) is won. In this case, the symbol seven 94 is stopped and displayed on the pay line in each of the variable display portions 21 to 25, and the payout becomes 100. Similarly, if the random number value sampled lies in a range of 1257˜1272, the winning combination of the triple BAR is won. In this case, the triple BAR 91 is stopped and displayed on the pay line in each of the variable display portions 21 to 25, and the payout becomes 40. And similarly, if the random number value sampled lies in a range of 1273˜1486, the winning combination of the single BAR is won. In this case, the single BAR 95 is stopped and displayed on the pay line in each of the variable display portions 21 to 25, and the payout becomes 10. And if the random number value sampled lies in a range of 1487˜1742, the winning combination of the cherry is won. In this case, the cherry 92 is stopped and displayed on the play line in each of the variable display portions 21 to 25, and the payout becomes 5.

Here, in a case that the random number value lies in a range of 1743˜16383, it leads to loss of winning combination (any winning combination cannot be won). In this case, symbol combination other than the winning combination is stopped and displayed on the pay line in each of variable display portions 21 to 25. And the payout cannot be obtained.

Comparing the lottery table of the winning combination in FIG. 8 with the lottery table of the winning combination in FIG. 6, the range that loss of winning combination occurs is narrower in the lottery table of FIG. 8 than in the lottery table of FIG. 6. Therefore, the winning probability for the winning combination in the first free game is set high. Especially, in comparison with the base game, the winning probability to win the winning combination of the seven (7) is set higher. This is based on that two symbol sevens 94 are increased in the symbol rows 41, 42, 43,44, and 45, as mentioned. Thus, if the game condition shifts to the first free game, the player can get a lot of coins in many cases.

Next, in a case that the second free game is conducted in the slot machine 1, the lottery table utilized when the lottery of the winning combination is conducted will be described with reference to FIG. 9. FIG. 9 is an explanatory view showing the lottery table of the winning combination utilized when the second free game is done.

In FIG. 9, a range of random number values utilized in the lottery table of the winning combination lie within 0˜16383. In a case that the random number value sampled by the random number sampling circuit 56 lies in a range of 0˜3, the joker is won. In this case, the joker 97 is stopped and displayed on the pay line in the variable display portion 23 and the game condition is again shifted to the second free game.

And in a case that the random number value sampled by the random number sampling circuit 56 lies in a range of 4˜4828, the winning combination of the seven (7) is won. In this case, the symbol seven 94 is stopped and displayed on the pay line in each of the variable display portions 21 to 25. Similarly, if the random number value sampled lies in a range of 4829˜4844, the winning combination of the triple BAR is won. In this case, the triple BAR 91 is stopped and displayed on the pay line in each of the variable display portions 21 to 25. And similarly, if the random number value sampled lies in a range of 4845˜5068, the winning combination of the single BAR is won. In this case, the single BAR 95 is stopped and displayed on the pay line in each of the variable display portions 21 to 25. And if the random number value sampled lies in a range of 5069˜5323, the winning combination of the cherry is won. In this case, the cherry 92 is stopped and displayed on the play line in each of the variable display portions 21 to 25.

Here, in a case that the random number value lies in a range of 5324˜16383, it leads to loss of winning combination (any winning combination cannot be won). In this case, symbol combination other than the winning combination is stopped and displayed on the pay line in each of variable display portions 21 to 25.

And as for the payouts in the second free game, such payouts are as same as those shown in the lottery table of the winning combination which is utilized when the lottery of the winning combination in the first free game in FIG. 7 is done.

Here, comparing the lottery table of the winning combination in the second free game with the lottery table of the winning combination in the base game in FIG. 6, the range that loss of winning combination occurs is narrower in the lottery table of FIG. 9 than in the lottery table of FIG. 6. Therefore, the winning probability for the winning combination in the second free game is set high. Especially, in comparison with the base game, the winning probability to win the winning combination of the seven (7) is set higher. This is based on that four symbol sevens 94 are increased in the symbol rows 41, 42, 43, 44, and 45, as mentioned. Thus, if the game condition shifts to the second free game, the player can get a lot of coins in many cases.

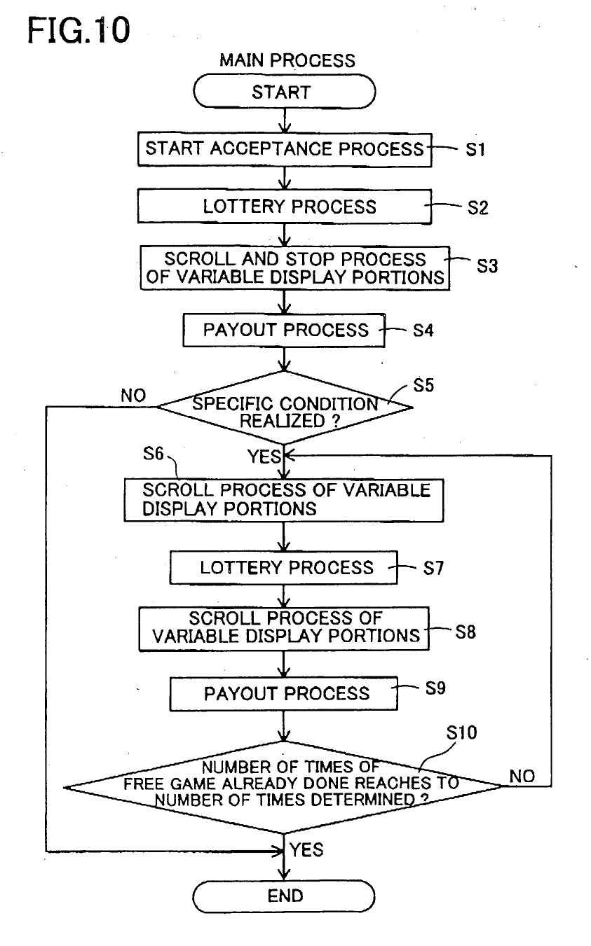

Next, the main process program executed in the slot machine 1 will be described with reference to FIG. 10. FIG. 10 is a flowchart of the main process program. In FIG. 10, first in-step (abbreviated as “S” hereinafter) 1, start acceptance process is done. This start acceptance process is process to receive the switch signal output from the start switch 57, the spin switch 58, the 1-BET switch 59, the 3-BET switch 60 or the 5-BET switch 61, based on operation of the start lever 17, the SPIN/REPEAT BET button 12, the 1-BET button 11, the 3-BET button 13 or the 5-BET button 14. At the time that the switch signal output from each switch is received, the base game is started.

In S2, based on the switch signal output from the start switch 57, the spin switch 58, the 1-BET switch 59, the 3-BET switch 60 or the 5-BET switch 61, various lottery processes are conducted. Concretely, the lottery of the winning combination in the base game is done by utilizing the lottery table of the winning combination (random number value range 1) of FIG. 6 in the base game. At that time, on the condition that the free game is triggered, the lottery of the first free game or the second free game is conducted by using the lottery table of the free game in FIG. 7. Further, the number of times that the free games are continuously executed is determined among 10 games, 20 games and 30 games.

After the lottery process in S2 is done as mentioned, the symbols (symbols in each of the symbol rows 41 to 45 shown in FIG. 3) are scrolled on the variable display portions 21 to 25, based on the switch signal, which is received In S1, output from the start switch 57, the spin switch 58, the 1-BET switch 59, the 3-BET switch 60 or the 5-BET switch 61. And if the stop buttons 26 to 30 corresponding to the variable display portions 21 to 25 on which the symbols are scrolled are pressed, scrolling of each of the symbols on the variable display portions 21 to 25 is stopped by using the switch signal output from the pressed stop button as the trigger.

Here, in the first embodiment, each of the stop buttons 26 to 30 has no relation with so-called “observation push” which is done for purpose to allow technical intervention by the player. And the switch signal output from each of the stop buttons 26 to 30 is used to the end only as the trigger when the symbols scrolled on the variable display portions 21 to 25 are stopped and displayed thereon. Therefore, the symbols on each of the variable display portions 21 to 25 are stopped and displayed thereon based on only the lottery result obtained in S2.

In S4, coins corresponding to the predetermined payout arc paid out according to the symbol combination in the winning combination which is stopped and displayed over the variable display portions 21 to 25 in S3. As mentioned in the above, the base game is conducted.

And after the payout process is finished in S4, it is determined in S5 whether a specific condition is realized or not. Here, concretely speaking, the specific condition corresponds to that the free game is triggered in the lottery process of S2. At that time, if it is determined that the specific condition is not realized (S5: NO), the main process is finished. On the other hand, if it is determined that the specific condition is realized (S5: YES), the procedure shifts to S6. In S6, scrolling of the symbols on the variable display portions 21 to 25 is automatically started and the free game is started. At that time, if the first free game is triggered in S2, the symbol rows 41 to 45 shown in FIG. 12 are utilized as the symbols scrolled on the variable display portions 21 to 25. On the other hand, if the second free game is triggered in S2, the symbol rows 41 to 45 shown in FIG. 14 are utilized as the symbols scrolled on the variable display portions 21 to 26. Thereafter, in order to stop of scrolling of the symbols on the variable display portions 21 to 25, it is called player's attention so that the player presses the stop buttons 26 to 30 by the words (for example, “switch on”) displayed on the lower liquid crystal display 4 or blinking of the stop buttons 26 to 30.

In S7, various lottery processes are conducted at the timing that the procedure shifts to S7. Concretely, if the first free game is already triggered, the lottery of the winning combination in the first free game is done by using the lottery table of the winning combination in the first free game shown in FIG. 8. On the other hand, if the second free game is already triggered, the lottery of the winning combination in the second free game is done by using the lottery table of the winning combination in the second free game shown in FIG. 9.

As mentioned, after the lottery process in S7 is finished, if the stop buttons 26 to 30 corresponding to the variable display portions 21 to 25 on which the symbols are scrolled are pressed by the player, scrolling of the symbols on the variable display portions 21 to 25 is stopped in S8 by using the switch signals output from the pressed stop buttons as the trigger.

Here, in the first embodiment, each of the stop buttons 26 to 30 has no relation with so-called “observation push” which is done for purpose to allow technical intervention by the player. And the switch signal output from each of the stop buttons 26 to 30 is used to the end only as the trigger when the symbols scrolled on the variable display portions 21 to 25 are stopped and displayed thereon. Therefore, the symbols on each of the variable display portions 21 to 25 are stopped and displayed thereon based on only the lottery result obtained in S7.

In S9, according to the symbol combination corresponding to the winning combination which is stopped and displayed over the variable display portions 21 to 25 in S8, coins corresponding to the predetermined payout are paid out. As mentioned in the above, the free game is conducted.

And after the payout process of S9 is finished, it is determined in S10 whether or not the number of times of the free game already done reaches to the number of times determined in S2. At that time, if it is determined that the number of times of the free game already done does not reach to the number of times determined in S2 (S10: NO), the procedure returns to S6 and the above process is repeated. On the other hand, if it is determined that the number of times of the free game already done reaches to the number of times determined in S2 (S10: YES), the main process program is finished.

As mentioned above, in the slot machine 1 according to the first embodiment, after the specific condition (winning of the trigger for the free game) is realized (S2), the lottery of the first free game or the second free game is conducted (S2). At that time, if the first free game is triggered, the symbol rows 41 to 45 shown in FIG. 11 are utilized (S6) as the symbols scrolled on the variable display portions 21 to 25 and the lottery of the winning combination in the first free game is done (S7) by utilizing the lottery table of the winning combination in the first free game shown in FIG. 8. Further, if the second free game is triggered, the symbol rows 41 to 45 shown in FIG. 14 are utilized (S6) as the symbols scrolled on the variable display portions 21 to 25 and the lottery of the winning combination in the second free game is done (S7) by utilizing the lottery table of the winning combination in the second free game shown in FIG. 9. Therefore, two or four of the symbol sevens 94, which are scrolled on the variable display portions 21 to 25, can be increased, thus the winning combination of the seven (7) can be easily won. Thereby, since the lottery of the winning combination is conducted corresponding to the number of the symbols which are utilized and scrolled on the variable display portions 21 to 25, various winning combinations can be easily won. Therefore, it can be given to the player expectation that the specific winning combination can be easily won, as a result, interest for games can be highly maintained.

And as shown in FIG. 16, if the symbol sevens 94 are stopped and displayed on the pay line in the variable display portions 21 to 24 and at the same time the symbol seven 94 is stopped and displayed under the pay line in the variable display portion 25, the player has an impression that the winning combination is not unfortunately won. However, as in the first free game, in a case that two of the symbols sevens 94, which are scrolled on the variable display portions 21 to 25, are increased, it can be given to the player an impression that the symbol combination corresponding to the winning combination can be stopped and displayed on the pay line by the increased symbol sevens 94 in the variable display portion 25, as shown in FIG. 11. Thus, expectation of the player can be raised. This situation is similarly obtained in the second free game in which four of the symbol sevens 94 scrolled on the variable display portions 21 to 25 are increased. Thus, it can be given to the player an impression that the symbol combination corresponding to the winning combination can be stopped and displayed on the pay line by the increased symbol sevens 94 in the variable display portion 25, as shown in FIG. 13. Thus, expectation of the player can be raised.

Further, according to the number of the symbol sevens 94 which are scrolled on the variable display portions 21 to 25 utilized in the first free game or the second free game, the lottery table of the winning combination in the first free game of FIG. 8 and the lottery table of the winning combination in the second free game of FIG. 9 are provided. Therefore, even if the number of the symbol seven 94 is changed (reduced), game process can be rapidly done by conducting a simple table control.

And it is provided in the slot machine 1 the stop buttons 26 to 30 producing the trigger for stopping and displaying the symbols scrolled on the variable display portions 21 to 25, and although the symbols are not stopped on the variable display portions 21 to 25 at the timing that the stop buttons 26 to 30 are pressed, it can be given to the player an impression that the symbol combination corresponding to the winning combination may be stopped and displayed under a beneficial state for the player that two or four of the symbol sevens 94 scrolled on the variable display portions 21 to 25 are increased.

Further, if the first free game is triggered, the lottery of the winning combination in the first free game is done by using the lottery table of the winning combination shown in FIG. 8 and if the second free game is triggered, the lottery of the winning combination in the second free game is done by using the lottery table of the winning combination shown in FIG. 9 (S7). Thereafter, the symbols are scrolled, stopped and displayed on the variable display portions 21 to 25 according to the lottery result by using stop instruction occurring when the player presses the stop buttons 26 to 30 as the trigger. At that time, since the symbol rows 41 to 45 (FIG. 12 or FIG. 13), in which two or four of the symbol sevens 94 are increased, are utilized, unnatural movement occurring when the symbols stop on the variable display portions 21 to 25 can be removed by using the increased two or four of the symbol sevens 94, even if operation timing of the stop buttons 26 to 30 is inconvenient.

Hereinafter, the second embodiment according to the present invention will be described. Here, the second embodiment has basically the same construction as that in the first embodiment. Thus, characteristic construction in the second embodiment will be mainly described hereinafter.

First, patterns of the pay line will be described with reference to FIG. 20. FIG. 20 is an explanatory view showing the pay line. Here, only the center pay line L2 is made active.

In the example shown in FIG. 20, it is shown a case that the symbol seven 94 is stopped and displayed along the center pay line L2.

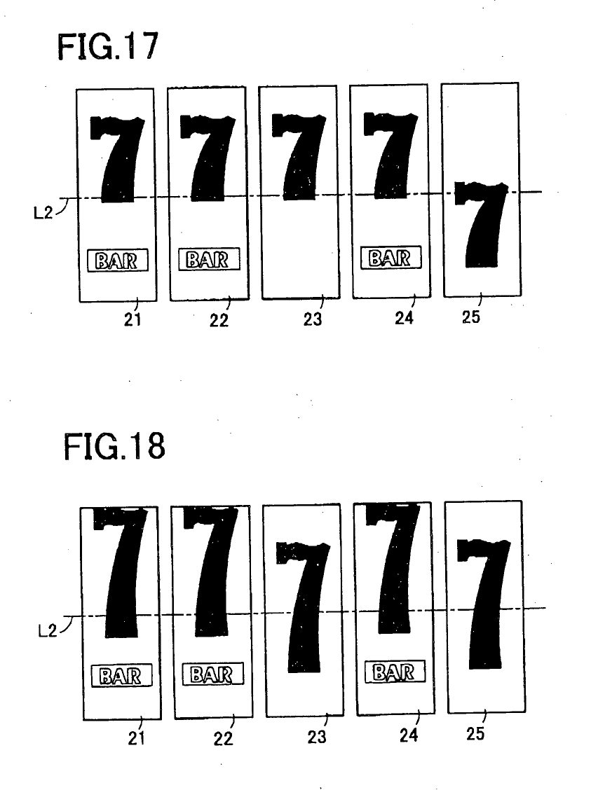

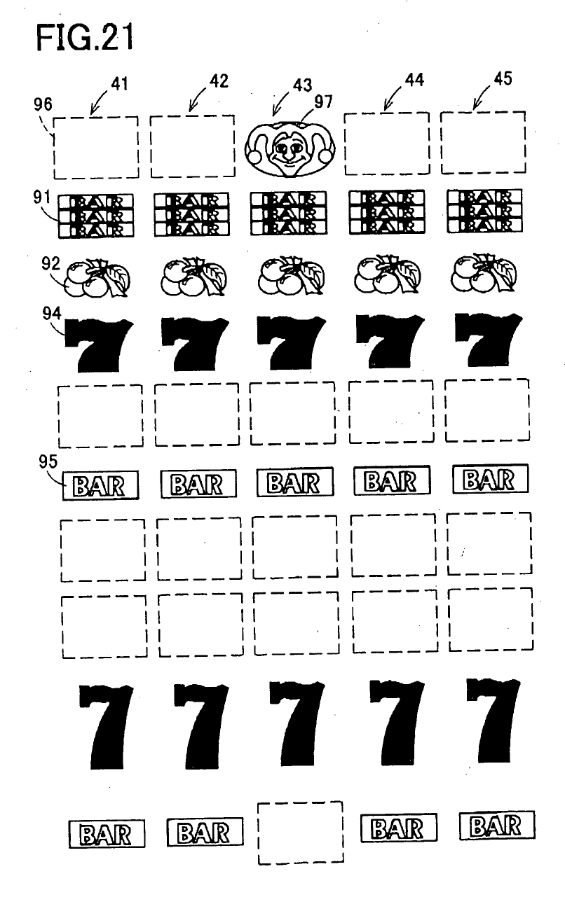

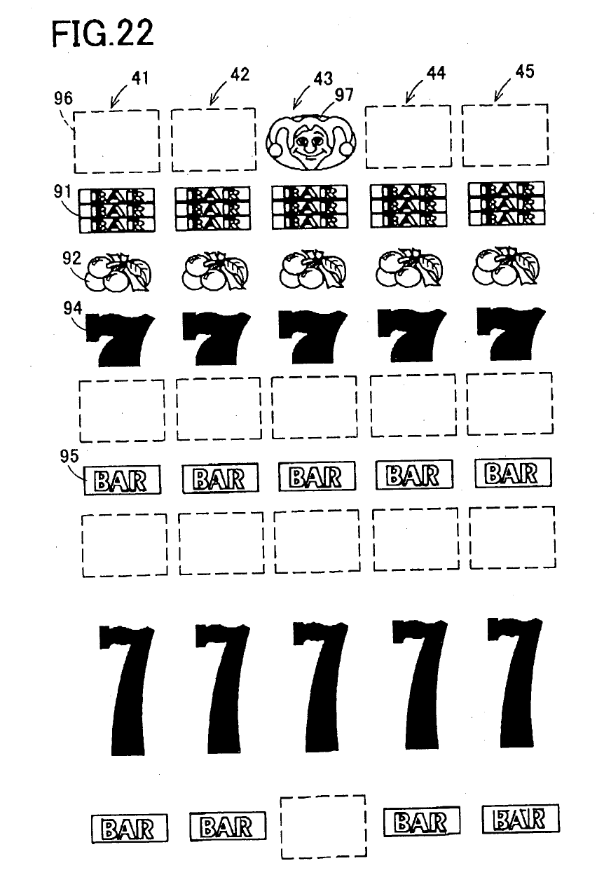

Next, it will be explained with reference to FIGS. 7, 17, 18, 21 and 22 the lottery table utilized when the lottery of free game is done and examples of the symbols and the symbol rows which are used in the free game and displayed on each of the variable display portions 21 to 25. FIG. 7 is an explanatory view showing the lottery table of the free game. FIG. 17 is an explanatory view showing the example of the symbols which are utilized in the first free game and displayed on each of the variable display portions 21 to 25. FIG. 18 is an explanatory view showing the examples of the symbols and the symbol rows which are utilized in the second free game and displayed on each of the variable display portions 21 to 25. FIG. 21 is an explanatory view schematically showing the symbol rows which are utilized in the first free game and displayed on each of variable display portions 21 to 25. FIG. 22 is an explanatory view schematically showing the symbol rows which are utilized in the second free game and displayed on each of variable display portions 21 to 25.

Here, as mentioned above, if the joker 97 is stopped and displayed on the pay line in the variable display portion 23, the game condition can be shifted to the free game after the base game is finished. As the free game, the first game and the second free game are provided beforehand.

As shown in FIG. 7, the random number values utilized in the lottery table of the free game lie within 0˜15. And in a case that the random number value sampled by the random number sampling circuit 56 lies in a range of 0˜12, the game condition is shifted to the first free game after the base game is finished. Further, when the first free game is conducted, the symbol rows 41, 42, 43, 44 and 46 shown in FIG. 21 arc utilized. Here, comparing the symbol rows 41 to 45 shown in FIG. 21 with the symbol rows in the base game shown in FIG. 3, one symbol seven 94 is enlarged twice in the vertical direction by utilizing one blank (area that no symbol exists) 96. Therefore, when the symbol seven 94 is stopped and displayed on the variable display portions 21 to 25, there will be a case that the symbol seven 94, which is enlarged twice in the vertical direction, is stopped and displayed, for example as shown in FIG. 17. At that time, in each of the variable display portions 21 to 25, one blank (area that no symbol exists) 96 is substantially changed to the symbol seven 94, thus it concludes that one symbol seven 94 is increased.

And if the random number value sampled by the random number sampling circuit 66 lies in a range of 13˜15, the game condition is shifted to the second free game after the base game is finished. Further, when the second free game is conducted, the symbol rows 41, 42, 43, 44 and 45 shown in FIG. 22 are utilized. Here, comparing the symbol rows shown in FIG. 22 with the symbol rows in the base game shown in FIG. 3, one symbol seven 94 is enlarged three times in the vertical direction by utilizing two blanks (area that no symbol exists) 96. Therefore, when the symbol seven 94 is stopped and displayed on the variable display portions 21 to 25, there will be a case that the symbol seven 94, which is enlarged three times in the vertical direction, is stopped and displayed, for example as shown in FIG. 18. At that time, in each of the variable display portions 21 to 25, two blanks (area that no symbol exists) 96 are substantially changed to the symbol seven 94, thus it concludes that two symbol sevens 94 are increased.

Next, in a case that the first free game is conducted in the slot machine 1, the lottery table utilized when the lottery of the winning combination is conducted will be described with reference to FIG. 8. FIG. 8 is an explanatory view showing the lottery table of the winning combination utilized when the first free game is done.

In FIG. 8, a range of random number values utilized in the lottery table of the winning combination lie within 0˜16383. In a case that the random number value sampled by the random number sampling circuit 56 lies in a range of 0˜3, the joker is won. In this case, the joker 97 is stopped and displayed on the pay line in the variable display portion 23 and the payout becomes twice.

And in a case that the random number value sampled by the random number sampling circuit 56 lies in a range of 4˜1256, the winning combination of the seven (7) is won. In this case, the symbol seven 94 including the symbol seven 94 enlarged twice in the vertical direction is stopped and displayed on the pay line in each of the variable display portions 21 to 25, and the payout becomes 100. Similarly, if the random number value sampled lies in a range of 1257˜1272, the winning combination of the triple BAR is won. In this case, the triple BAR 91 is stopped and displayed on the pay line in each of the variable display portions 21 to 25, and the payout becomes 40. And similarly, if the random number value sampled lies in a range of 1273˜1486, the winning combination of the single BAR is won. In this case, the single BAR 95 is stopped and displayed on the pay line in each of the variable display portions 21 to 25, and the payout becomes 10. And if the random number value sampled lies in a range of 1487˜1742, the winning combination of the cherry is won. In this case, the cherry 92 is stopped and displayed on the play line in each of the variable display portions 21 to 25, and the payout becomes 5.

Here, in a case that the random number value lies in a range of 1743˜16383, it leads to loss of winning combination (any winning combination cannot be won). In this case, symbol combination other than the winning combination is stopped and displayed on the pay line in each of variable display portions 21 to 25. And the payout cannot be obtained.

Comparing the lottery table of the winning combination in FIG. 9 with the lottery table of the winning combination in FIG. 6, the range that loss of winning combination occurs is narrower in the lottery table of FIG. 9 than in the lottery table of FIG. 6. Therefore, the winning probability for the winning combination in the first free game is set high. Especially, in comparison with the base game, the winning probability to win the winning combination of the seven (7) is set higher. This is based on that one symbol seven 94 is substantially increased in the symbol rows 41, 42, 43,44, and 45, as mentioned. The reason is as follows. Although the symbol rows 41 to 45 shown in FIG. 21 are utilized when the first free game is conducted, one symbol seven 94 is enlarged twice in the vertical direction by using one blank (area that no symbol exists) 96 in the symbol rows 41 to 45 shown in FIG. 21, in comparison with the symbol rows utilized in the base game as shown in FIG. 3. Thus, if the game condition shifts to the first free game, the player can get a lot of coins in many cases.

Next, in a case that the second free game is conducted in the slot machine 1, the lottery table utilized when the lottery of the winning combination is conducted will be described with reference to FIG. 9. FIG. 9 is an explanatory view showing the lottery table of the winning combination utilized when the second free game is done.

In FIG. 9, a range of random number values utilized in the lottery table of the winning combination lie within 0˜16383. In a case that the random number value sampled by the random number sampling circuit 56 lies in a range of 0˜3, the joker is won. In this case, the joker 97 is stopped and displayed on the pay line in the variable display portion 23 and the game condition is again shifted to the second free game.

And in a case that the random number value sampled by the random number sampling circuit 56 lies in a range of 4˜4828, the winning combination of the seven (7) is won. In this case, the symbol seven 94 including the symbol seven 94 enlarged three times in the vertical direction is stopped and displayed on the pay line in each of the variable display portions 21 to 25. Similarly, if the random number value sampled lies in a range of 4829˜4844, the winning combination of the triple BAR is won. In this case, the triple BAR 91 is stopped and displayed on the pay line in each of the variable display portions 21 to 25. And similarly, if the random number value sampled lies in a range of 4845˜5068, the winning combination of the single BAR is won. In this case, the single BAR 95 is stopped and displayed on the pay line in each of the variable display portions 21 to 25. And if the random number value sampled lies in a range of 5069˜5323, the winning combination of the cherry is won. In this case, the cherry 92 is stopped and displayed on the play line in each of the variable display portions 21 to 25.

Here, in a case that the random number value sampled lies in a range of 5324˜16383, it leads to loss of winning combination (any winning combination cannot be won). In this case, symbol combination other than the winning combination is stopped and displayed on the pay line in each of variable display portions 21 to 25.

And as for the payouts in the second free game, such payouts are as same as those shown in the lottery table of the winning combination which is utilized when the lottery of the winning combination in the first free game in FIG. 8 is done.

Here, comparing the lottery table of the winning combination in the second free game with the lottery table of the winning combination in the base game in FIG. 6, the range that loss of winning combination occurs is narrower in the lottery table of FIG. 9 than in the lottery table of FIG. 6. Therefore, the winning probability for the winning combination in the second free game is set high. Especially, in comparison with the base game, the winning probability to win the winning combination of the seven (7) is set higher. This is based on that two symbol sevens 94 are substantially increased in the symbol rows 41, 42, 43,44, and 45, as mentioned. The reason is as follows. Although the symbol rows 41 to 45 shown in FIG. 22 are utilized when the first free game is conducted, one symbol seven 94 is enlarged three times in the vertical direction by using two blanks (area that no symbol exists) 96 in the symbol rows 41 to 45 shown in FIG. 22, in comparison with the symbol rows utilized in the base game as shown in FIG. 3. Thus, if the game condition shifts to the second free game, the player can get a lot of coins in many cases.

Next, the main process program executed in the slot machine 1 will be described with reference to FIG. 10. FIG. 10 is a flowchart of the main process program. In FIG. 10, first in step (abbreviated as “S” hereinafter) 1, start acceptance process is done. This start acceptance process is process to receive the switch signal output from the start switch 57, the Spin switch 58, the 1-BET switch 59, the 3-BET switch 60 or the 5-BET switch 61, based on operation of the start lever 17, the SPIN/REPEAT BET button 12, the 1-BET button 11, the 3-BET button 13 or the 5-BET button 14. At the time that the switch signal output from each switch is received, the base game is started.

In S2, based on the switch signal output from the start switch 5i, the spin switch 58, the 1-BET switch 59, the 3-BET switch 60 or the 5-BET switch 61, various lottery processes are conducted. Concretely, the lottery of the winning combination in the base game is done by utilizing the lottery table of the winning combination (random number value range 1) of FIG. 6 in the base game. At that time, on the condition that the free game is triggered, the lottery of the first free game or the second free game is conducted by using the lottery table of the free game in FIG. 7. Further, the number of times that the free games are continuously executed is determined among 10 games, 20 games and 30 games.

After the lottery process in S2 is done as mentioned, the symbols (symbols in each of the symbol rows 41 to 45 shown in FIG. 3) are scrolled on the variable display portions 21 to 25, based on the switch signal, which is received In S1, output from the start switch 57, the spin switch 68, the 1-BET switch 59, the 3-BET switch 60 or the 5-BET switch 61. And if the stop buttons 26 to 30 corresponding to the variable display portions 21 to 25 on which the symbols are scrolled are pressed, scrolling of each of the symbols on the variable display portions 21 to 25 is stopped by using the switch signal output from the pressed stop button as the trigger.

Here, in the first embodiment, each of the stop buttons 26 to 30 has no relation with so-called “observation push” which is done for purpose to allow technical intervention by the player. And the switch signal output from each of the stop buttons 26 to 30 is used to the end only as the trigger when the symbols scrolled on the variable display portions 21 to 25 are stopped and displayed thereon. Therefore, the symbols on each of the variable display portions 21 to 25 are stopped and displayed thereon based on only the lottery result obtained in S2.

In S4, coins corresponding to the predetermined payout are paid out according to the symbol combination in the winning combination which is stopped and displayed over the variable display portions 21 to 25 in S3. As mentioned in the above, the base game is conducted.

And after the payout process is finished in S4, it is determined in S6 whether a specific condition is realized or not. Here, concretely speaking, the specific condition corresponds to that the free game is triggered in the lottery process of S2. At that time, if it is determined that the specific condition is not realized (S5: NO), the main process is finished. On the other hand, if it is determined that the specific condition is realized (S5: YES), the procedure shifts to S6. In S6, scrolling of the symbols on the variable display portions 21 to 25 is automatically star-ted and the free game is started. At that time, if the first free game is triggered in S2, the symbol rows 41 to 45 shown in FIG. 21 are utilized as the symbols scrolled on the variable display portions 21 to 25. On the other hand, if the second free game is triggered in S2, the symbol rows 41 to 45 shown in FIG. 22 are utilized as the symbols scrolled on the variable display portions 21 to 25. Thereafter, in order to stop of scrolling of the symbols on the variable display portions 21 to 25, it is called player's attention so that the player presses the stop buttons 26 to 30 by the words (for example, “switch on”) displayed on the lower liquid crystal display 4 or blinking of the stop buttons 26 to 30.

In S7, various lottery processes are conducted at the timing that the procedure shifts to S7. Concretely, if the first free game is already triggered, the lottery of the winning combination in the first free game is done by using the lottery table of the winning combination in the first free game shown in FIG. 8. On the other hand, if the second free game is already triggered, the lottery of the winning combination in the second free game is done by using the lottery table of the winning combination in the second free game shown in FIG. 9.

As mentioned, after the lottery process in S7 is finished, if the stop buttons 26 to 30 corresponding to the variable display portions 21 to 25 on which the symbols are scrolled are pressed by the player, scrolling of the symbols on the variable display portions 21 to 25 is stopped in S8 by using the switch signals output from the pressed stop buttons as the trigger. At that time, if the first free game is triggered and the winning combination of seven (7) is won in S7, the symbols are stopped and displayed as shown in FIG. 17. On the other hand, if the second free game is triggered and the winning combination of seven (7), the symbols are stopped and displayed as shown in FIG. 18.

Here, in the second embodiment, each of the stop buttons 26 to 30 has no relation with so-called “observation push” which is done for purpose to allow technical intervention by the player. And the switch signal output from each of the stop buttons 26 to 30 is used to the end only as the trigger when the symbols scrolled on the variable display portions 21 to 25 are stopped and displayed thereon. Therefore, the symbols on each of the variable display portions 21 to 25 are stopped and displayed thereon based on only the lottery result obtained in S7.

In S9, according to the symbol combination corresponding to the winning combination which is stopped and displayed over the variable display portions 21 to 25 in S8, coins corresponding to the predetermined payout are paid out. As mentioned in the above, the free game is conducted.

And after the payout process of S9 is finished, it is determined in S10 whether or not the number of times of the free game already done reaches to the number of times determined in S2. At that time, if it is determined that the number of times of the free game already done does not reach to the number of times determined in S2 (S10: NO), the procedure returns to S6 and the above process is repeated. On the other hand, if it is determined that the number of times of the free game already done reaches to the number of times determined in S2 (S10: YES), the main process program is finished.

As mentioned above, in the slot machine 1 according to the second embodiment, after the specific condition (winning of the trigger for the free game) is realized (S2), the lottery of the first free game or the second free game is conducted (S2). At that time, if the first free game is triggered, the lottery of the winning combination is done in the first free game by utilizing the lottery table of the winning combination shown in FIG. 8 (S7). Further, the symbol rows 41 to 45 (one of the symbol sevens 94 is enlarged twice in the vertical direction) shown in FIG. 21 are utilized as the symbols scrolled on the variable display portions 21 to 25, therefore one blank (area that no symbol exists) 96 is substantially changed to the symbol seven 94 and it concludes that one symbol seven 94 is increased in each of the variable display portions 21 to 25. Further, if the second free game is triggered, the lottery of the winning combination is done in the second free game by utilizing the lottery table of the winning combination shown in FIG. 9 (S7). And the symbol rows 41 to 45 (one of the symbol sevens 94 is enlarged three times in the vertical direction) shown in FIG. 22 is utilized as the symbols scrolled on the variable display portions 21 to 25, therefore two blanks (area that no symbol exists) 96 are substantially changed to the symbol sevens 94 and it concludes that two symbol sevens 94 are increased in each of the variable display portions 21 to 25. Therefore, one or two of the symbol sevens 94, which are scrolled on the variable display portions 21 to 25, can be increased, thus the winning combination of the seven (7) can be easily won. Thereby, since the lottery of the winning combination is conducted corresponding to the number of the symbols which are utilized and scrolled on the variable display portions 21 to 25, various winning combinations can be easily won. Therefore, it can be given to the player expectation that the specific winning combination can be easily won, as a result, interest for games can be highly maintained.

And as shown in FIG. 20, if the symbol sevens 94 are stopped and displayed on the pay line in the variable display portions 21 to 24 and at the same time the symbol seven 94 is stopped and displayed under the pay line in the variable display portion 25, the player has an impression that the winning combination is not unfortunately won. However, as in the first free game, in a case that one of the symbols sevens 94, which are scrolled on each of the variable display portions 21 to 25, is substantially increased, it can be given to the player an impression that the symbol combination corresponding to the winning combination can be stopped and displayed on the pay line by the symbol seven 94, which is enlarged twice, in the variable display portion 25, as shown in FIG. 17. Thus, expectation of the player can be raised. This situation is similarly obtained in the second free game in which two of the symbol sevens 94 scrolled on each of the variable display portions 21 to 25 are substantially increased. Thus, it can be given to the player an impression that the symbol combination corresponding to the winning combination can be stopped and displayed on the pay line by the symbol seven 94, which is enlarged three times, in the vertical direction in the variable display portion 25, as shown in FIG. 18. Thus, expectation of the player can be raised.

Further, according to the multiple of the symbol seven 94 which is enlarged in the vertical direction on the variable display portions 21 to 25 utilized in the first free game or the second free game, the lottery table of the winning combination in the first free game of FIG. 8 and the lottery table of the winning combination in the second free game of FIG. 9 are provided. Therefore, even if the multiple of the symbol seven 94 is changed (increased), game process can be rapidly done by conducting a simple table control.

And it is provided in the slot machine 1 the stop buttons 26 to 30 producing the trigger for stopping and displaying the symbols scrolled on the variable display portions 21 to 25, and although the symbols are not stopped on the variable display portions 21 to 25 at the timing that the stop buttons 26 to 30 are pressed, it can be given to the player an impression that the symbol combination corresponding to the winning combination may be stopped and displayed under a beneficial state for the player that one or two of the symbol seven (s) 94 is/are substantially increased in each of the variable display portions 21 to 25 by using in the first free game or the second free game the symbol rows 41 to 45 (FIG. 21 or FIG. 22) in each of which one of the symbol seven 94 is enlarged twice or three times in the vertical direction.

Further, if the first free game is triggered, the lottery of the winning combination in the first free game is done by using the lottery table of the winning combination shown in FIG. 8 and if the second free game is triggered, the lottery of the winning combination in the second free game is done by using the lottery table of the winning combination shown in FIG. 9 (S7). Thereafter, the symbols are scrolled, stopped and displayed on the variable display portions 21 to 25 according to the lottery result by using stop instruction occurring when the player presses the stop buttons 26 to 30 as the trigger. At that time, since the symbol rows 41 to 45 (FIG. 21 or FIG. 22), in each of which one of the symbol sevens 94 is enlarged twice or three times in the vertical direction, are utilized, unnatural movement occurring when the symbols stop on the variable display portions 21 to 25 can be removed by using the symbol seven 94 enlarged twice or three times in the vertical direction, even if operation timing of the stop buttons 26 to 30 is inconvenient.

The present invention is not limited to the first embodiment and the second embodiment, and of course, various improvements and modifications can be done within the scope of the present invention.

For example, in the slot machine 1 of the first embodiment, although it is automatically determined that two or four of the symbol sevens 94 scrolled on each of the variable display portions 21 to 25 are increased, based on the lottery result by using the lottery table for free games shown in FIG. 7, this determination may be done as follows.

That is to say, the lottery table in FIG. 7 is treated as the lottery table for changing the number of the symbols scrolled on the variable display portions 21 to 25 and the random number value is sampled by the random number sampling circuit 66 based on the switch signal output from the start switch 57, the spin switch 58, the 1-BET switch 59, the 3-BET switch 60 or the 5-BET switch 61, which are confirmed in S1 in FIG. 10. Further, based on the above sampled random number value the number of the utilized symbols scrolled on the variable display portions 21 to 25 may be determined. For example, among the range of the random number value within 0˜15 in the lottery table shown in FIG. 7, if the sampled random number value lies within the range of 1˜12, one blank (area that no symbol exists) 96 may be changed to the symbol seven 94 among the symbols scrolled on each of the variable display portions 21 to 25, and if the sampled random number value lies in the range of 13˜15, three blanks 96 may be changed to the symbol sevens 94 among the symbols scrolled on each of the variable display portions 21 to 25. At that time, the random number value may be obtained every one of the variable display portions 21 to 25 and the blank 95 may be changed to the symbol seven every variable display portion.

According to the above, in addition to the first free game and the second free game, the blank 96 can be changed to the symbol seven 94 even in the base game among the symbols scrolled on the variable display portions 21 to 25.

And the slot machine 1 may be constructed as follows. That is, it is arranged an insertion button, which can insert coins to change the number of utilized symbols scrolled on the variable display portions 21 to 25 from the credit (stored coin number) stored in the slot machine 1, and the number of utilized symbols are changed according to operation number of the insertion button. In this case, in change process to change the number of utilized symbols, the operation number is counted in S1 of FIG. 10 and the number of utilized symbols is changed according to the counted operation number. For example, among the symbols scrolled on each of the variable display portions 21 to 25, two blanks 96 are changed to the symbol sevens 94 based on that the insertion button is pressed one time and four blanks 96 are changed to the symbol sevens 94 based on that the insertion button is pressed two times. At that time, among the symbols scrolled on each of the variable display portions 21 to 25, coin number necessary for changing two blanks 96 to the symbol sevens 94 can be, for example, set to 100. And coin number necessary for changing four blanks 96 to the symbol sevens 94 can be, for example, set to 300.

And as mentioned, among the symbols scrolled on each of the variable display portions 21 to 25, after the number that the blank 96 is changed to the symbol seven 94 is determined, if the two blanks 96 are changed to the symbol sevens 94, the lottery of the winning combination in the base game is done by using the winning combination lottery table (range 1 of random number values) which is used in the base game shown in FIG. 6 in the lottery process of S2. Further in S3, the symbol rows 41 to 45 shown in FIG. 12 are utilized as the symbols scrolled on each of the variable display portions 21 to 25. On the other hand, if four blanks 96 are changed to the symbol sevens 94, the lottery of the winning combination in the base game is done by using the winning combination lottery table (range 2 of random number values) which is used in the base game shown in FIG. 6 in the lottery process of S2. Further in S3, the symbol rows 41 to 45 shown in FIG. 14 are utilized as the symbols scrolled on each of the variable display portions 21 to 25. According to this, in addition to the first free game and the second free game, the blank 96 can be changed to the symbol seven 94 even in the base game among the symbols scrolled on the variable display portions 21 to 25.

Here, the above situation may be similarly obtained if the number that the blank 96 is changed to the symbol seven 94 among the symbols scrolled on the variable display portions 21 to 25 is controlled corresponding to bet number by operation of the start lever 17, the SPIN/REPEAT BET button 12 the 1-BET button 11, the 3-BET button 13 or the 5-BET button 14.

Further, in order to change the number of utilized symbols scrolled on the variable display portions 21 to 25, although the slot machine 1 of the first embodiment is constructed so that the blank 96 displayed on the lower liquid crystal display 4 is changed to the symbol seven 94 and the changed symbol seven 94 is scrolled, the slot machine 1 is not limited to this construction. The slot machine 1 may be constructed as follows. For example, as in the conventional slot machine, five reels, on outer periphery of each of which the symbol row 41, 42, 43, 44, 45 is formed respectively, may be rotatably supported, and if the number of utilized symbols which are scrolled is changed, illumination means such as LED may be arranged in rear side of each reel and the symbol scrolled in each reel may be emphasized by illuminating through the illumination means.

And although the stop buttons 26 to 30 are arranged corresponding to each of the variable display portions 21 to 25 and the trigger signal is output by pressing the stop button corresponding to one of the variable display portions 21 to 25 on which the symbol is scrolled, the symbols may be automatically stopped on four variable display portions among the variable display portions 21 to 25 except for one variable display portion and only the switch signal output from the stop button corresponding to the remaining variable display portion may be accepted. And in a case that each of the stop buttons 26 to 30 is not pressed for a predetermined time, each of the variable display portions 21 to 25 may be automatically stopped and displayed as the predetermined time is elapsed.

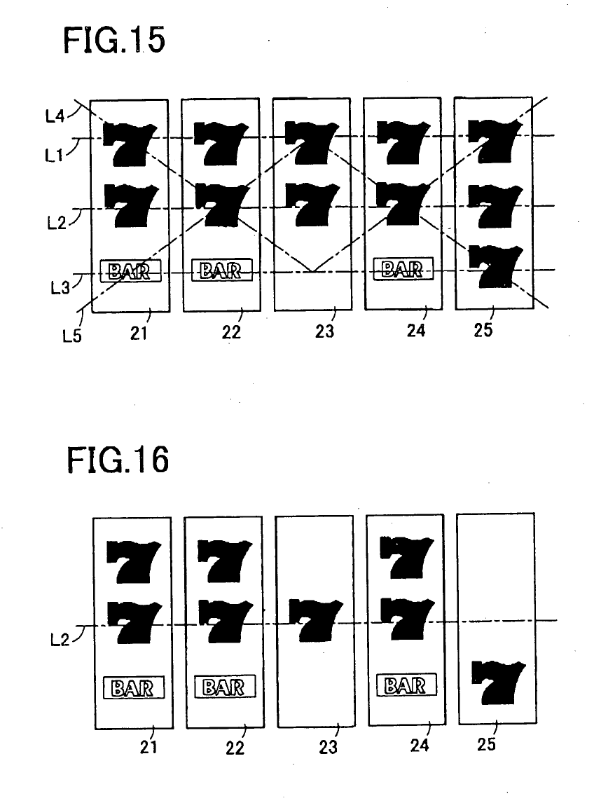

Further, in the slot machine 1 according the first embodiment, as shown in FIG. 16, although only the center line L2 is used as the pay line, the pattern of the pay line may be changed corresponding to the number of the symbol seven 94 which is changed from the blank 96 among the symbols scrolled on the variable display portions 21 to 25. For example, as shown in FIG. 15, in addition to the center line L2, the slot machine 1 may have the top line L1, the bottom line L3, the cross down-cross up line L4 which is constructed by combining the cross down line and the cross up line and the cross up-cross down line L5 which is constructed by combining the cross up lien and the cross down line, and the pay line which is made active may be determined corresponding to the number of the symbol seven 94 which is changed from the blank 96 among the symbols scrolled on the variable display portions 21 to 25. Here, in the example shown in FIG. 15, the winning combination seven (7) is realized based on that the symbol sevens 94 are stopped and displayed along the top line L1 and the center line L2, thus the winning combination seven (7) can be easily won if the top line L1 is made active in addition to the center line L2. Therefore, it can be given to the player expectation that the specific winning combination can be easily won, thus interest for games can be highly maintained.

That is to say, state of the winning combination and the pay line which is made active among the lines L1 to L5 can be changed corresponding to the number of the symbol seven 94 which is changed from the blank 96 among the symbols scrolled on the variable display portions 21 to 25, thereby variations of the game can be increased and variegated game can be done.

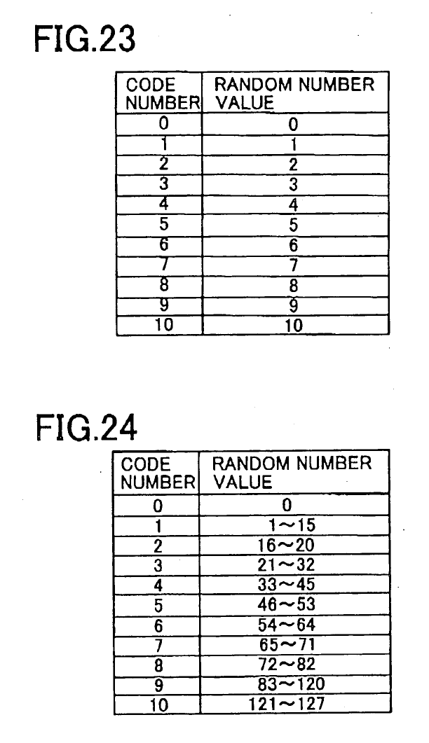

And in the slot machine 1 according to the first embodiment, although all symbols, which are stopped and displayed on the pay line over each of the variable display portions 21 to 25, are determined according to the random number value sampled by the random number sampling circuit 56 (FIGS. 6, 8 and 9), the symbol stopped and displayed on the pay line may be determined every each of the variable display portions 21 to 25. In order to embody this concept, for example, code numbers 0˜10 are allotted to the symbol rows 41 to 45 each of which corresponds to each of the variable display portions 21 to 25 shown in FIGS. 3, 12 and 14, and the lottery table shown in FIG. 23 is provided. And five random number values are sampled so as to correspond to each of the variable display portions 21 to 25. For example, if the random number value corresponding to the variable display portion 21 is the code number 1, the symbol to which the code number 1 is allotted is stopped and displayed on the pay line, and if the random number value corresponding to the variable display portion 22 is the code number 2, the symbol to which the code number 2 is allotted is stopped and displayed on the pay line. And if the random number value corresponding to the variable display portion 23 is the code number 3, the symbol to which the code number 3 is allotted is stopped and displayed on the pay line and if the random number value corresponding to the variable display portion 24 is the code number 4, the symbol to which the code number 4 is allotted is stopped and displayed on the pay line. And if the random number value corresponding to the variable display portion 25 is the code number 5, the symbol to which the code number 5 is allotted is stopped and displayed on the pay line.

Here, in the lottery table shown in FIG. 23, although the random number value is evenly allotted against each of the code numbers, the lottery table, in which the random number values are unevenly allotted against the code numbers as shown in FIG. 24, may be utilized in order that the joker 97 to shift to the free game is made difficult to be stopped and displayed on the pay line.

And in the slot machine according to the first embodiment, although the blank 96 is changed to the symbol seven 94 among the symbols scrolled on each of the variable display portions 21 to 25 (FIGS. 3, 12 and 14), any one of the triple BAR 91, the cherry 92 and the single BAR 95 except for the symbol seven 94 May be changed and the symbol to be changed may be any one of the triple BAR 91, the cherry 92, the symbol seven 94 and single BAR 95 except for the blank 96.

Further, for example, in the slot machine 1 according to the second embodiment, based on that it is utilized the symbol rows 41 to 45 in each of which one of the symbol sevens 94 is enlarged twice or three times in the vertical direction (FIG. 21 or FIG. 22), it is automatically determined on the basis of the lottery result by the lottery table for the free game shown in FIG. 6 that one or two of the symbol seven (s) 94 is/are substantially increased. However, the slot machine 1 is not limited to the above and may be constructed as follows.

That is to say, the lottery table in FIG. 7 is treated as the lottery table for selecting one of the symbol rows 41 to 45 (FIG. 14 or FIG. 15) in which one of the symbol sevens 94 is enlarged twice or three times and selection of the symbol row May be determined according to the random number value sampled by the random number sampling circuit 56 based on the switch signal output from the start switch 57, the spin switch 58, the 1-BET switch 59, the 3-BET switch 60 or the 5-BET switch 61, which are confirmed in S1 in FIG. 10.

For example, among the range of the random number value within 0˜15 which is utilized in the lottery table shown in FIG. 7, if the sampled random number value lies within the range of 1˜12, the symbol rows 41 to 45 in which one of the symbol sevens 94 is enlarged twice in the vertical direction (FIG. 21) are selected and if the sampled random number value lies within the range of 13˜15, the symbol rows 41 to 45 in which one of the symbol sevens 94 is enlarged three times in the vertical direction (FIG. 22) are selected. At that time, the random number value may be obtained every one of the variable display portions 21 to 25 and the symbol row in which one of the symbol sevens 94 is enlarged twice or three times in the vertical direction may be selected every variable display portion. According to the above, in addition to the first free game and the second free game, one or two of the symbol sevens 94 can be substantially increased even in the base game.

And in order to select one of the symbol rows 41 to 45 in which one of the symbol sevens 94 is enlarged twice or three times in the vertical direction, it is arranged an insertion button, which can insert coins from the credit (stored coin number) stored in the slot machine 1, and the slot machine 1 may be constructed so as to select one of the symbol rows 41 to 45 in which one of the symbol sevens 94 is enlarged twice or three times in the vertical direction corresponding to operation number of the insertion button. In this case, in change process to select one of the symbol rows 41 to 45 in each of which one of the symbol sevens 94 is enlarged twice or three times in the vertical direction (FIG. 21 or FIG. 22), the operation number of the insertion button is counted in S1 of FIG. 10 and the change process may be conducted according to the counted operation number. For example, when the insertion button is operated one time, the symbol rows 41 to 45 in each of which one of the symbol sevens 94 is enlarged twice in the vertical direction (FIG. 21) are selected, and when the insertion button is operated two times, the symbol rows 41 to 45 in each of which one of the symbol sevens 94 is enlarged three times in the vertical direction (FIG. 22) are selected. At that time, coin number necessary for selecting the symbol rows 41 to 45 in each of which one of the symbol sevens 94 is enlarged twice in the vertical direction (FIG. 21) can be, for example, set to 100. And coin number necessary for selecting the symbol rows 41 to 45 in each of which one of the symbol sevens 94 is enlarged three times in the vertical direction (FIG. 22) can be, for example, set to 300.

And as mentioned, after the symbol rows 41 to 45 in each of which one of the symbol sevens 94 is enlarged twice or three times in the vertical direction (FIG. 21 or FIG. 22) are selected, if the symbol rows 41 to 45 in each of which one of the symbol sevens 94 is enlarged twice in the vertical direction (FIG. 21) are selected, the winning combination lottery is done in the base game in the lottery process in S2 by using the winning combination lottery table (range 1 of random number values) in the base game shown in FIG. 6, and in S3, the symbols are scrolled, stopped and displayed on the variable display portions 21 to 26 by using the symbol rows 41 to 45 in each of which one of the symbol sevens 94 is enlarged twice in the vertical direction (FIG. 21). On the other hand, if the symbol rows 41 to 45 in each of which one of the symbol sevens 94 is enlarged three times in the vertical direction (FIG. 22) are selected, the winning combination lottery is done in the base game in the lottery process in S2 by using the winning combination lottery table (range 2 of random number values) in the base game shown in FIG. 6, and in S3, the symbols are scrolled, stopped and displayed on the variable display portions 21 to 25 by using the symbol rows 41 to 45 in each of which one of the symbol sevens 94 is enlarged three times in the vertical direction (FIG. 22). According to this, in addition to the first free game and the second free game, one of two of the symbol sevens 94 can be substantially increased by using the symbol rows 41 to 45 in each of which one of the symbol sevens 94 is enlarged twice or three times in the vertical direction (FIG. 21 or FIG. 22) even in the base game.

Here, the above situation may be similarly obtained if the symbol rows 41 to 45 in each of which one of the symbol sevens 94 is enlarged twice or three times in the vertical direction (FIG. 21 or FIG. 22) are elected corresponding to bet number by operation of the start lever 17, the SPIN/REPEAT BET button 12, the 1-BET button 11, the 3-BET button 13 or the 5-BET button 14.

And in the second embodiment, in order to substantially increase one or two of the symbol sevens 94, although the slot machine 1 of the second embodiment is constructed so that the symbol rows 41 to 45 in each of which one of the symbol sevens 94 is enlarged twice or three times in the vertical direction (FIG. 21 or FIG. 22), the slot machine 1 is not limited to this construction. The slot machine 1 may be constructed as follows. For example, as in the conventional slot machine, five reels, on outer periphery of each of which the symbol row 41, 42, 43, 44, 45 is formed respectively, may be rotatably supported, and illumination means such as LED may be arranged in rear side of each reel, and the symbol, which is enlarged in the vertical direction may be emphasized by illuminating through the illumination means.

And although the stop buttons 26 to 30 are arranged corresponding to each of the variable display portions 21 to 25 and the trigger signal is output by pressing the stop button corresponding to one of the variable display portions 21 to 25 on which the symbol is scrolled, the symbols may be automatically stopped on four variable display portions among the variable display portions 21 to 25 except for one variable display portion and only the switch signal output from the stop button corresponding to the remaining variable display portion may be accepted. And in a case that each of the stop buttons 26 to 30 is not pressed for a predetermined time, each of the variable display portions 21 to 25 may be automatically stopped and displayed as the predetermined time is elapsed.

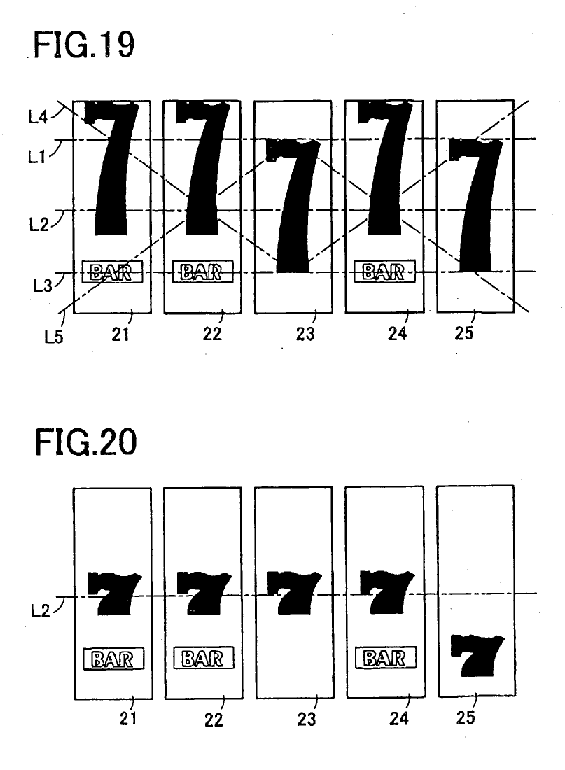

Further, in the slot machine 1 according the second embodiment, as shown in FIG. 20, although only the center line L2 is used as the pay line, the pattern of the pay line may be changed corresponding to enlargement multiple (shape) of the symbol seven 94 which is stopped and displayed on the variable display portions 21 to 25. For example, as shown in FIG. 19, in addition to the center line L2, the slot machine 1 may have the top line L1, the bottom line L3, the cross down-cross up line L4 which is constructed by combining the cross down line and the cross up line and the cross up-cross down line L5 which is constructed by combining the cross up lien and the cross down line, and the pay line which is made active may be determined corresponding to the enlargement multiple (shape) of the symbol seven 94 which is stopped and displayed on the variable display portions 21 to 25. Here, in the example shown in FIG. 19, the winning combination seven (7) is realized based on that the symbol sevens 94 are stopped and displayed along the center line L2 and the cross down-cross up line 4, thus the winning combination seven (7) can be easily won if the cross down-cross up line 4 is made active in addition to the center line L2. Therefore, it can be given to the player expectation that the specific winning combination can be easily won, thus interest for games can be highly maintained.

That is to say, state of the winning combination and the pay line which is made active among the lines L1 to L5 can be changed corresponding to the enlargement multiple (shape) of the symbol seven 94 which is stopped and displayed on the variable display portions 21 to 25, thereby variations of the game can be increased and variegated game can be done.

And in the slot machine of the second embodiment, although the symbol rows 41 to 45 en each of which one of the symbol sevens 94 is enlarged twice or three times in the vertical direction (FIG. 21 or FIG. 22), in a case that the symbol seven 94 has one blank 96 at the upper position or lower position of the symbol seven 94, the symbol seven 94 may be enlarged twice or three times in the upper or lower direction and stopped and displayed when the symbol seven 94 and the blank 96 are stopped and displayed on the variable display portions 21 to 25.

And in the slot machine 1 according to the second embodiment, although all symbols, which are stopped and displayed on the pay line over each of the variable display portions 21 to 25, is determined according to the random number value sampled by the random number sampling circuit 56 (FIGS. 6, 8 and 9), the symbol stopped and displayed on the pay line may be determined every each of the variable display portions 21 to 25. In order to embody this concept, for example, code numbers 0˜10 are allotted to the symbol rows 41 to 45 each of which corresponds to each of the variable display portions 21 to 25 shown in FIGS. 3, 12 and 14, and the lottery table shown in FIG. 23 is provided. And five random number values are sampled so as to correspond to each of the variable display portions 21 to 25. For example, if the random number value corresponding to the variable display portion 21 is the code number 1, the symbol to which the code number 1 is allotted is stopped and displayed on the pay line, and if the random number value corresponding to the variable display portion 22 is the code number 2, the symbol to which the code number 2 is allotted is stopped and displayed on the pay line. And if the random number value corresponding to the variable display portion 23 is the code number 3, the symbol to which the code number 3 is allotted is stopped and displayed on the pay line and if the random number value corresponding to the variable display portion 24 is the code number 4, the symbol to which the code number 4 is allotted is stopped and displayed on the pay line. And if the random number value corresponding to the variable display portion 25 is the code number 5, the symbol to which the code number 5 is allotted is stopped and displayed on the pay line.

Here, as shown in FIG. 21, as the symbol rows scrolled, stopped and displayed on the variable display portions 21 to 25, if the symbol rows 41 to 45 in each of which one of the symbol sevens 94 is enlarged twice in the vertical direction are utilized, two of the code numbers 0˜5 are allotted to the symbol seven 94 which is enlarged twice in the vertical direction.

And as shown in FIG. 22, as the symbol rows scrolled, stopped and displayed on the variable display portions 21 to 25, if the symbol rows 41 to 45 in each of which one of the symbol sevens 94 is enlarged three times in the vertical direction are utilized, three of the code numbers 0˜5 are allotted to the symbol seven 94 which is enlarged three times in the vertical direction.

Here, in the lottery table shown in FIG. 23, although the random number value is evenly allotted against each of the code numbers, the lottery table, in which the random number values are unevenly allotted against the code numbers as shown in FIG. 24, may he utilized in order that the joker 97 to shift to the free game is made difficult to be stopped and displayed on the pay line.

In the slot machine. 1 according to the second embodiment, although the symbols lines 41 to 45 in each of which one of the symbol sevens 94 is enlarged twice or three times in the vertical direction (FIG. 21 or FIG. 22) are utilized, any one of the triple BAR 91, the cherry 92 and the single BAR 95 may be enlarged if such symbol has the blank 96 at the upper position or lower position thereof.

Further, in the slot machine 1 according to the second embodiment, although the symbols lines 41 to 45 in each of which one of the symbol sevens 94 is enlarged twice or three times in the vertical direction (FIG. 21 or FIG. 22) are utilized, such symbol may be enlarged twice˜five times in the horizontal direction over the variable display portions 21 to 25.

And both the first embodiment and the second embodiment mentioned above can be carried out in the slot machine 1 at the same time.

1. A gaming machine having a display device with a plurality of variable display portions on each of which symbols are variably displayed, a payout being given when the symbols variably displayed on each variable display portion are stopped along a pay line with a predetermined winning combination, the gaming machine comprising:
a variable display controller for controlling variable display of the symbols conducted on each of the variable display portions;
a symbol number controller for controlling a number of the symbols variably displayed on each of the variable display portions, when a specific condition is realized; and
a winning combination lottery device for conducting a lottery of the winning combination corresponding to the symbol number controlled by the symbol number controller.

2. The gaming machine according to claim 1, further comprising:
a plurality of base game symbol rows each of which includes a plural kinds of symbols which are variably displayed on each of the variable display portions by the variable display controller; and
a base game winning combination lottery table for storing plural winning combinations in the base game corresponding to the base game symbol rows, the base game winning combination lottery table being utilized in the base game in which the variable display of the symbols are conducted on each of the variable display portions by the variable display controller based on the symbols included in each of the base game symbol rows;
wherein the winning combination lottery device conducts the lottery of the winning combinations in the base game according to the base game winning combination lottery table.

3. The gaming machine according to claim 2, wherein a trigger symbol is included in at least one of the normal symbol rows, and
wherein the specific condition is realized based on that the trigger symbol is stopped on the pay line.

4. The gaming machine according to claim 3, wherein when the specific condition is realized the base game is shifted to one of a plural free games after finished.

5. The gaming machine according to claim 4, wherein at least a first free game and a second free game are provided in the plural free games.

6. The gaming machine according to claim 5, further comprising:
a free game lottery table utilized in a lottery to determine whether the base game is shifted to any of the first free game and the second free game; and
a free game determination device for determining any of the first free game and the second free game done after the base game based on the free game lottery table.

7. The gaming machine according to claim 5, further comprising:
a plurality of first free game symbol rows each of which includes a plural kinds of symbols which are variably displayed on each of the variable display portions by the variable display controller when the first free game is conducted; and
a plurality of second free game symbol rows each of which includes a plural kinds of symbols which are variably displayed on each of the variable display portions by the variable display controller when the second free game is conducted;
wherein the use number of the symbols is set more in the first free game symbol rows and the second free game symbol rows than in the base game symbol rows.

8. The gaming machine according to claim 7, wherein the use number of the symbols is greater in the second free game symbol rows than in the first free game symbol rows, and
wherein the symbol number controller selects the first free game symbol rows or the second free game symbol rows based on a determination result by the free game determination device and controls the use number of the symbols according the selected symbol rows.

9. The gaming machine according to claim 8, wherein the winning combination lottery device conducts the lottery of the winning combinations in the first free game or the second free game corresponding to the use number of the symbols based on a selection result by the symbol number controller.

10. The gaming machine according to claim 8, further comprising:
a first free game winning combination lottery table which is utilized in the first free game and provided corresponding to the first free game symbol rows, the first free game winning combination lottery table storing the winning combinations in the first free game; and
a second free game winning combination lottery table which is utilized in the second free game and provided corresponding to the second free game symbol rows, the second free game winning combination lottery table storing the winning combinations in the second free game;
wherein the winning combination lottery device conducts the lottery of the winning combinations in the first free game or the second free game according to the first free game winning combination lottery table or the second free game winning combination lottery table based on the determination result by the free game determination device.

11. The gaming machine according to claim 1, further comprising:
a stop instruction device for instructing stop of the symbols variably displayed on each of the variable display portions by the variable display controller; and
a stop controller for stopping the symbols on the variable display portions based on a stop instruction from the stop instruction device.

12. A gaming machine having a display device with a plurality of variable display portions on each of which symbols are variably displayed, a payout being given when the symbols variably displayed on each variable display portion are stopped along a pay line with a predetermined winning combination, the gaming machine comprising:
a variable display controller for controlling variable display of the symbols conducted on each of the variable display portions;
a symbol shape controller for controlling shapes of the symbols variably displayed on each of the variable display portions, when a specific condition is realized; and
a winning combination lottery device for conducting a lottery of the winning combination corresponding to the symbol shape controlled by the symbol shape controller.

13. The gaming machine according to claim 12, further comprising:
a plurality of base game symbol rows each of which includes a plural kinds of symbols which are variably displayed on each of the variable display portions by the variable display controller; and
a base game winning combination lottery table for storing plural winning combinations in the base game corresponding to the base game symbol rows, the base game winning combination lottery table being utilized in the base game in which the variable display of the symbols are conducted on each of the variable display portions by the variable display controller based on the symbols included in each of the base game symbol rows;
wherein the winning combination lottery device conducts the lottery of the winning combinations in the base game according to the base game winning combination lottery table.

14. The gaming machine according to claim 13, wherein a trigger symbol is included in at least one of the normal symbol rows, and
wherein the specific condition is realized based on that the trigger symbol is stopped on the pay line.

15. The gaming machine according to claim 14, wherein when the specific condition is realized the base game is shifted to one of a plural free games after finished.

16. The gaming machine according to claim 15, wherein at least a first free game and a second free game are provided in the plural free games.

17. The gaming machine according to claim 16, further comprising:
a free game lottery table utilized in a lottery to determine whether the base game is shifted to any of the first free game and the second free game; and
a free game determination device for determining any of the first free game and the second free game done after the base game based on the free game lottery table.

18. The gaming machine according to claim 16, further comprising:
a plurality of first free game symbol rows each of which includes a plural kinds of symbols which are variably displayed on each of the variable display portions by the variable display controller when the first free game is conducted; and
a plurality of second free game symbol rows each of which includes a plural kinds of symbols which are variably displayed on each of the variable display portions by the variable display controller when the second free game is conducted;
wherein the symbol shape is set larger in the second free game symbol rows than in the first free game symbol rows.

19. The gaming machine according to claim 18, wherein the symbol shape controller selects the first free game symbol rows or the second free game symbol rows based on a determination result by the free game determination device and controls the symbol shape according the selected symbol rows.

20. The gaming machine according to claim 19, wherein the winning combination lottery device conducts the lottery of the winning combinations in the first free game or the second free game corresponding to the symbol shape based on a selection result by the symbol shape controller.

21. The gaming machine according to claim 19, further comprising:
a first free game winning combination lottery table which is utilized in the first free game and provided corresponding to the first free game symbol rows, the first free game winning combination lottery table storing the winning combinations in the first free game; and
a second free game winning combination lottery table which is utilized in the second free game and provided corresponding to the second free game symbol rows, the second free game winning combination lottery table storing the winning combinations in the second free game;
wherein the winning combination lottery device conducts the lottery of the winning combinations in the first free game or the second free game according to the first free game winning combination lottery table or the second free game winning combination lottery table based on the determination result by the free game determination device.

22. The gaming machine according to claim 18, wherein the symbol shape controller controls the symbol shape in the first free game symbol rows and the second free game symbol rows by enlarging the symbols in the base game symbol rows with a predetermined multiple.

23. The gaming machine according to claim 22, wherein the multiple in the second free game symbol rows is set larger than the multiple in the first free game symbol rows.

24. The gaming machine according to claim 12, further comprising:
a stop instruction device for instructing stop of the symbols variably displayed on each of the variable display portions by the variable display controller; and
a stop controller for stopping the symbols on the variable display portions based on a stop instruction from the stop instruction device.
